(19) United States
(12) Patent Application Publication
(10) Pub. No.: US 2025/0131105 A1
(43) Pub. Date: Apr. 24, 2025

(54) MANAGEMENT METHOD, APPARATUS, SYSTEM AND STORAGE MEDIUM FOR USER HANDWRITING DATA

(71) Applicant: SHENZHEN EAGLESOUL TECHNOLOGY CO., LTD., Shenzhen, Guangdong (CN)

(72) Inventors: Qiwei LU, Pu'ning, Guangdong (CN); Ning YANG, Dalian, Liaoning (CN); Fangyuan CHEN, Macheng, Hubei (CN); Shengqiang LIU, Dalian, Liaoning (CN)

(21) Appl. No.: 18/682,784

(22) PCT Filed: Aug. 20, 2021
(86) PCT No.: PCT/CN2021/113657

§ 371 Date: Feb. 9, 2024

(30) Foreign Application Priority Data
Aug. 13, 2021 (CN) 2021109343562

(51) Int. Cl. G06F 21/60; G06F 3/0354; G06F 3/04883; G06F 40/109

(52) U.S. Cl. CPC G06F 21/602; G06F 3/03545; G06F 3/04883; G06F 40/109

(57) ABSTRACT

The present disclosure relates to the fields of big data and blockchain, and provides a management method, apparatus, system and storage medium for user handwriting data, which are used to realize accurate data tracing and copyright protection of digital contents and other relevant information. The management method for the user handwriting data includes: performing blockchain on-chain registration and unified management on initial code sources and code segments to obtain code source and code segment information registered on a blockchain; acquiring code-paving information from the code source and code segment information registered on the blockchain according to code-paving requirements, performing typesetting and code-paving on an original digital content file to obtain a typeset and code-paved digital version file, and performing blockchain on-chain registration on the typeset and code-paved digital version file to obtain target digital version file information.

### CROSS-REFERENCE TO RELATED APPLICATIONS

This Application is a national stage application of PCT/CN2021/113657. This application claims priorities from PCT Application No. PCT/CN2021/113657, filed Aug. 20, 2021, and from the Chinese patent application 2021109343562 filed Aug. 13, 2021, the content of which are incorporated herein in the entirety by reference.

### TECHNICAL FIELD

The present disclosure relates to the fields of big data and blockchain, and in particular to a management method, apparatus, system and storage medium for user handwriting data.

### DESCRIPTION OF THE PRIOR ART

Driven by the development of the Internet, digital works continue to develop in a direction of networking, informatization and digitization, and the number of digital contents and digital works disseminated over the Internet is showing an explosive growth trend. With the development of modern information technology and the upgrading of network intelligent terminal technology, handwriting review scenes and digital contents begin to be fused, and the management of handwriting-fused digital contents and other relevant information also begins to be realized. At present, the management method for handwriting-fused digital contents is to use different types of handwriting generation devices to classify, store and call the handwriting-fused digital contents according to different standards.

However, since technical standards for pens and codes produced by technical manufacturers of handwriting generation devices are not shared, that is, generation rules, coding standards, code segments etc., are not uniform and cannot be used universally, code segments open and authorized to publishers, printers, consumers and other users, and code sources can only be managed by individual manufacturers, and cannot be open in a credible manner, universal and easy to use, which leads to pain points related to accurate data tracing and copyright protection of digital contents and other relevant information.

### SUMMARY

The present disclosure provides a management method, apparatus, system and storage medium for user handwriting data, which are used to realize accurate data tracing and copyright protection of digital contents and other relevant information.

According to a first aspect of the present disclosure, there is provided a management method for user handwriting data, comprising:
acquiring initial code sources and code segments, and performing blockchain on-chain registration and unified management on the initial code sources and code segments to obtain code source and code segment information registered on a blockchain, the initial code sources and code segments being code sources and code segments from various dot-matrix digital pen manufacturers or various dot-matrix digital pen developers;
acquiring code segments required for code-paving from the code source and code segment information registered on the blockchain according to code-paving requirements, performing typesetting and code-paving on an original digital content file through a preset typesetting and code-paving system to obtain a typeset and code-paved digital version file, and performing blockchain on-chain registration on the typeset and code-paved digital version file to obtain target digital version file information, the target digital version file information comprising a target digital version file, on-chain registration information and copyright information of the target digital version file;
acquiring user handwriting data written by a user on a printed matter of the typeset and code-paved digital version file and fed back to an intelligent dot-matrix digital pen system, as user handwriting data to be processed on the printed matter of the digital version file, performing on-chain preprocessing on the user handwriting data to be processed, inquiring a corresponding typeset and code-paved digital version file according to the user handwriting data to be processed after the on-chain preprocessing and code point information on the printed matter, and performing copyright compliance verification on a file copyright of the typeset and code-paved digital version file and the used code sources and code segments to finally obtain compliant candidate user handwriting data, the printed matter of the digital version file being a printed matter of the target digital version file information; and
performing code source and code segment compliance verification on the candidate user handwriting data, digital copyright compliance verification of handwriting carrier, and on-chain registration and on-chain storage management to obtain target user handwriting data.

According to a second aspect of the present disclosure, there is provided a management apparatus for user handwriting data, comprising:
a code source and code segment on-chain management module configured for acquiring initial code sources and code segments, and performing blockchain on-chain registration and unified management on the initial code sources and code segments to obtain code source and code segment information registered on a blockchain, the initial code sources and code segments being code sources and code segments from various dot-matrix digital pen manufacturers or various dot-matrix digital pen developers;
a typesetting and code-paving module configured for acquiring code segments required for code-paving from the code source and code segment information registered on the blockchain according to code-paving requirements, performing typesetting and code-paving on an original digital content file through a preset typesetting and code-paving system to obtain a typeset and code-paved digital version file, and performing blockchain on-chain registration on the typeset and code-paved digital version file to obtain target digital version file information, the target digital version file information comprising a target digital version file, on-chain registration information and copyright information of the target digital version file;
a first verification module configured for acquiring user handwriting data written by a user on a printed matter of the typeset and code-paved digital version file and fed back to an intelligent dot-matrix digital pen system, as user handwriting data to be processed on the printed matter of the digital version file, performing on-chain preprocessing on the user handwriting data to be processed, inquiring a corresponding typeset and code-paved digital version file according to the user handwriting data to be processed after the on-chain preprocessing and code point information on the printed matter, and performing copyright compliance verification on a file copyright of the typeset and code-paved digital version file and the used code sources and code segments to finally obtain compliant candidate user handwriting data; and
a second verification module configured for performing code source and code segment compliance verification on the candidate user handwriting data, digital copyright compliance verification of handwriting carrier, and on-chain registration and on-chain storage management to obtain target user handwriting data.

According to a third aspect of the present disclosure, there is provided a management system for user handwriting data, which comprises a blockchain copyright authentication and management system, a blockchain-based digital typesetting and code-paving printing system, and an intelligent dot-matrix digital pen system; wherein the blockchain copyright authentication and management system comprises a production link subsystem and an application link subsystem, the production link subsystem being configured for management of code sources and code segments and a typeset and code-paved digital file, and the application link subsystem being configured for application of a typeset and code-paved printed matter, on-chain registration and storage of handwriting, copyright inquiry and compliance application;
the intelligent dot-matrix digital pen system comprises an intelligent dot-matrix digital pen and an application system server;
the production link subsystem is connected to the blockchain-based digital typesetting and code-paving printing system;
the blockchain-based digital typesetting and code-paving printing system is indirectly connected to the intelligent dot-matrix digital pen system through the application link subsystem;
the intelligent dot-matrix digital pen system is connected to the blockchain copyright authentication and management system;
the production link subsystem is configured for acquiring initial code sources and code segments, and performing blockchain on-chain registration and unified management on the initial code sources and code segments to obtain code source and code segment information registered on a blockchain, the initial code sources and code segments being code sources and code segments from various dot-matrix digital pen manufacturers or various dot-matrix digital pen developers;
the blockchain-based digital typesetting and code-paving printing system is configured for acquiring code segments required for code-paving from the code source and code segment information registered on the blockchain according to code-paving requirements, performing typesetting and code-paving on an original digital content file through a preset typesetting and code-paving system to obtain a typeset and code-paved digital version file, and performing blockchain on-chain registration on the typeset and code-paved digital version file to obtain target digital version file information, the target digital version file information comprising a target digital version file, on-chain registration information and copyright information of the target digital version file;
the intelligent dot-matrix digital pen is configured for sending user handwriting data to be processed on a printed matter of the digital version file to the application system server, the user handwriting data to be processed on the printed matter of the digital version file being user handwriting data written by a user on the printed matter of the typeset and code-paved digital version file and fed back to the intelligent dot-matrix digital pen system;
the application system server is configured for performing on-chain preprocessing on the user handwriting data to be processed to obtain the user handwriting data to be processed after the on-chain preprocessing, and sending the user handwriting data to be processed after the on-chain preprocessing to the application link subsystem; and
the application link subsystem is configured for acquiring user handwriting data written by a user on the printed matter of the typeset and code-paved digital version file and fed back to the intelligent dot-matrix digital pen system, as user handwriting data to be processed on the printed matter of the digital version file, performing on-chain preprocessing on the user handwriting data to be processed, inquiring a corresponding typeset and code-paved digital version file according to the user handwriting data to be processed after the on-chain preprocessing and code point information on the printed matter, and performing copyright compliance verification on a file copyright of the typeset and code-paved digital version file and the used code sources and code segments to finally obtain compliant candidate user handwriting data, the printed matter of the digital version file being a printed matter of the target digital version file information; and performing code source and code segment compliance verification on the candidate user handwriting data, digital copyright compliance verification of handwriting carrier, and on-chain registration and on-chain storage management to obtain target user handwriting data.

According to a fourth aspect of the present disclosure, there is provided a computer-readable storage medium, which stores a computer program that, when running on a computer, causes the computer to carry out the management method for user handwriting data described above.

The technical solution provided by the present disclosure includes: acquiring initial code sources and code segments, and performing blockchain on-chain registration and unified management on the initial code sources and code segments to obtain code source and code segment information registered on a blockchain, the initial code sources and code segments being code sources and code segments from various dot-matrix digital pen manufacturers or various dot-matrix digital pen developers; acquiring code segments required for code-paving from the code source and code segment information registered on the blockchain according to code-paving requirements, performing typesetting and code-paving on an original digital content file through a preset typesetting and code-paving system to obtain a typeset and code-paved digital version file, and performing blockchain on-chain registration on the typeset and code-paved digital version file to obtain target digital version file information, the target digital version file information comprising a target digital version file, on-chain registration information and copyright information of the target digital version file; acquiring user handwriting data written by a user on the printed matter of the typeset and code-paved digital version file and fed back to the intelligent dot-matrix digital pen system, as user handwriting data to be processed on the printed matter of the digital version file, performing on-chain preprocessing on the user handwriting data to be processed, inquiring a corresponding typeset and code-paved digital version file according to the user handwriting data to be processed after the on-chain preprocessing and code point information on the printed matter, and performing copyright compliance verification on a file copyright of the typeset and code-paved digital version file and the used code sources and code segments to finally obtain compliant candidate user handwriting data, the printed matter of the digital version file being a printed matter of the target digital version file information; and performing code source and code segment compliance verification on the candidate user handwriting data, digital copyright compliance verification of handwriting carrier, and on-chain registration and on-chain storage management to obtain target user handwriting data. In embodiments of the present disclosure, with the blockchain, core data (initial code sources and code segments, code segments required for code-paving, and user handwriting data to be processed) of various links in the process is used for on-chain registration, and associating and mapping are performed on the data (the initial code sources and code segments, the code segments required for code-paving, and the user handwriting data to be processed) based on link dependency relationships, which solves problems regarding to data tracing and copyright management caused by the fact that code segments open and authorized to publishers, printers, consumers and other users, and code sources can only be managed by individual manufacturers, and cannot be open in a credible manner, universal and easy to use, and realizes credible tracing and copyright management of the initial code sources and code segments, target code-paving information and the user handwriting data to be processed, thus improving the data tracing accuracy and copyright protection degree of digital contents and other relevant information.

### BRIEF DESCRIPTION OF THE DRAWINGS

FIG. 1 is a schematic diagram of an embodiment of a management method for user handwriting data in embodiments of the present disclosure;

FIG. 2 is a schematic diagram of another embodiment of a management method for user handwriting data in embodiments of the present disclosure;

FIG. 3 is a schematic diagram of an embodiment of a management apparatus for user handwriting data in embodiments of the present disclosure;

FIG. 4 is a schematic diagram of another embodiment of a management apparatus for user handwriting data in embodiments of the present disclosure;

FIG. 5 is a schematic structure diagram of a management system for user handwriting data in embodiments of the present disclosure; and

FIG. 6 is another schematic structure diagram of a management system for user handwriting data in embodiments of the present disclosure.

### DETAILED DESCRIPTION OF THE PREFERRED EMBODIMENTS

Embodiments of the present disclosure provide a management method, apparatus, system and storage medium for user handwriting data, which improve the data tracing accuracy and copyright protection degree of digital contents and other relevant information.

Terms “first”, “second”, “third”, “fourth” and so on (if any) in the description and claims of the present disclosure and the above drawings are used to distinguish similar objects, and are not necessarily used to describe a specific order or sequence. It is to be understood that the terms so used are interchangeable under appropriate circumstances such that the embodiments described herein can be practiced in sequences other than those illustrated or described herein. Furthermore, terms “comprising” or “having” and any variations thereof, are intended to cover a non-exclusive inclusion, for example, a process, method, system, product or device containing a sequence of steps or elements is not necessarily limited to those steps or elements explicitly listed, which instead may include other steps or elements not explicitly listed or inherent to the process, method, product or device.

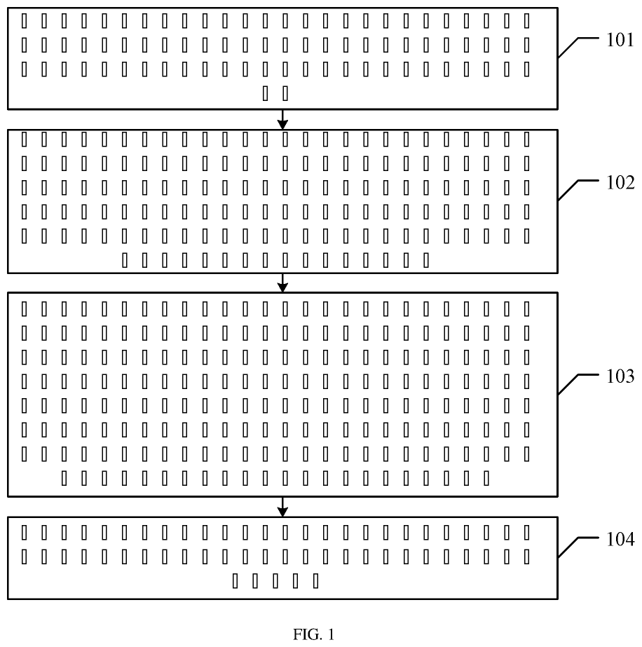

For ease of understanding, a specific process of the embodiments of the present disclosure is described below. Referring to FIG. 1, an embodiment of the management method for user handwriting data in the embodiments of the present disclosure includes steps 101 to 104.

At step 101, initial code sources and code segments are acquired, and blockchain on-chain registration and unified management are performed on the initial code sources and code segments to obtain code source and code segment information registered on a blockchain, the initial code sources and code segments being code sources and code segments from various dot-matrix digital pen manufacturers or various dot-matrix digital pen developers.

It can be understood that the execution subject of the present disclosure may be a management apparatus for user handwriting data, or a terminal or server corresponding to a management system applied to user handwriting data, which is not specifically limited here. The embodiments of the present disclosure are illustrated by taking the server corresponding to the management system applied to the user handwriting data (hereinafter referred to as the server) as the execution subject as an example.

Code sources and code segments from multiple different dot-matrix digital pen manufacturers (or multiple different dot-matrix digital pen developers) are acquired in advance through compliant and formal channels, which are then stored in a preset database so as to realize unified management on the code sources and code segments from the multiple different dot-matrix digital pen manufacturers (or multiple different dot-matrix digital pen developers), where the way of storing to the preset database may be at least one of distributed storage, caching and mirror storage. The server calls code source management systems (that is, multiple preset code source management systems) of different dot-matrix digital pen manufacturers (or different dot-matrix digital pen developers), and extracts corresponding code sources and code segments to be processed from the preset database. Dot-matrix digital pens may be intelligent dot-matrix digital pens and/or ordinary dot-matrix digital pens, and the intelligent dot-matrix digital pens include dot-matrix ballpoint pens, dot-matrix pencils, dot-matrix fountain pens and dot-matrix brush pens. The code sources and code segments at this time (i.e., the initial code sources and code segments) may be understood as the original, unused metadata. In code-paving, the code segments used are copies of the metadata, a same code segment is allowed to be used for code-paving multiple times; and the initial code sources and code segments serve for code-paving on paper.

The server performs data cleaning, security detection and classification on the code sources and code segments to be processed, to obtain initial code sources and code segments; and acquires the initial code sources and code segments and merchant information corresponding to the initial code sources and code segments, and establishes a corresponding relation between the initial code sources and code segments and the merchant information. The initial code sources and code segments are used to indicate the code sources and code segments from various dot-matrix digital pen manufacturers or various dot-matrix digital pen developers. The code sources and code segments at this time, that is, “the initial handwriting code sources and code segments”, may be understood as the original, unused metadata. In code-paving, the code segments used are copies of the metadata, and a same code segment is allowed to be used for code-paving multiple times.

The server performs block data packaging, metadata extraction and metadata directory replication on the initial code sources and code segments and the merchant information between which the corresponding relation has been established, to obtain processed code sources and code segments. Specifically, according to a chain data structure of a preset blockchain, the initial code sources and code segments and the merchant information between which the corresponding relation has been established are packaged into block data for transaction broadcasting, block consensus, contract logic processing and storing, to obtain data to be processed. Key structure metadata extraction is performed on the data to be processed to obtain target metadata. The target metadata is replicated to a data directory of the blockchain, so as to obtain the processed code sources and code segments.

The server performs authorization and verification, authorization token distribution, and key encryption and distribution on the processed code sources and code segments to obtain code source and code segment information registered on the blockchain. Specifically, according to preset verification information, authorization and verification are performed on the processed code sources and code segments. Once the verification is passed, an authorization token and a key pair for the processed code sources and code segments are generated, and the processed code sources and code segments are identified and encrypted with the authorization token and the key pair, to obtain the code source and code segment information registered on the blockchain. The code source and code segment information registered on the blockchain may be data on the blockchain.

At step 102, code segments required for code-paving are acquired from the code source and code segment information registered on the blockchain according to code-paving requirements, typesetting and code-paving are performed on an original digital content file through a preset typesetting and code-paving system to obtain a typeset and code-paved digital version file, and blockchain on-chain registration is performed on the typeset and code-paved digital version file to obtain target digital version file information, the target digital version file information including a target digital version file, on-chain registration information and copyright information of the target digital version file.

The server receives a request for typesetting and code-paving, and performs analyzing and compliance verification on the request for typesetting and code-paving. The server extracts corresponding code sources and code segments from the code source and code segment information registered on the blockchain based on the request for typesetting and code-paving that has passed the compliance verification to obtain code sources and code segments to be verified, determines whether the code sources and code segments to be verified has been registered, if yes, performs compliance verification on the code sources and code segments to be verified to obtain the code sources and code segments to be verified that has passed the compliance verification, and if not, removes unregistered ones from the code sources and code segments to be verified to obtain the code sources and code segments to be verified after being removed, and performs compliance verification on the code sources and code segments to be verified after being removed to obtain the code sources and code segments to be verified that has passed the compliance verification. Further, based on a request for code-paving, the server acquires a number of code points required for code-paving directly from the blockchain (i.e., the code sources and code segments registered on the blockchain). The request for code-paving carries information of a code-paving user/organization/merchant, required code sources, and the number of code points corresponding to the code sources required for code-paving. It is responsible for retrieving compliant code segments and returning them on the chain. Therefore, in this case, there is no verification of code sources and code segments during code-paving. For the request for code-paving, instead of directly interacting with the blockchain to obtain code points, a code segment (this code segment was also registered on the chain when it was initialized) is preset in a code-paving service. It is not needed for the code-paving service to calculate the returned code points on the blockchain, but to use the code points in the preset code segment. However, whether the authorization of this code segment is valid or not requires the compliance verification on the blockchain. In addition, records about the use of code points may be registered on the blockchain for subsequent tracing. In this case, there is a compliance verification on code segment usage; and based on the request for typesetting and code-paving that has passed the verification, dot code extraction is performed on the code sources and code segments to be verified that has passed the compliance verification to obtain the code segments required for code-paving. The code segments required for code-paving include, but are not limited to, code source types, code segments, and the number of code points for typeset and code-paved dot codes. According to the information of the code-paving user/organization, after the information of the user/organization and the authorization information are verified through the blockchain, the code sources that the code-paving user/organization is authorized to use is acquired from the chain, and after a required length of code segments for code-paving are acquired from the code sources, a subsequent code-paving operation is carried out.

The server performs recognizable graphic code conversion through a preset graphics algorithm (which may be a computer graphics algorithm) on the code segments required for code-paving to obtain an image graphic code, and performs uniform distribution, coverage, and graphic code-paving on each page of an original digital content file through a preset typesetting and code-paving system to obtain a typeset and code-paved digital version file, so as to realize the typesetting and code-paving, where the code segments required for code-paving are processed through graphics algorithm operations and program processes, and each code point corresponds to generation of an image graphic code. Blockchain on-chain information verification, blockchain transaction broadcasting, block consensus and contract logic processing are performed on the typeset and code-paved digital version file to realize blockchain on-chain verification and on-chain registration, so as to obtain target digital version file information. The target digital version file information includes a target digital version file, on-chain registration information and copyright information after the on-chain registration of the target digital version file.

At step 103, user handwriting data written by a user on a printed matter of the typeset and code-paved digital version file and fed back to an intelligent dot-matrix digital pen system is acquired as user handwriting data to be processed on the printed matter of the digital version file, on-chain preprocessing is performed on the user handwriting data to be processed, a corresponding typeset and code-paved digital version file is inquired according to the user handwriting data to be processed after the on-chain preprocessing and code point information on the printed matter, and copyright compliance verification is performed on a file copyright of the typeset and code-paved digital version file and the used code sources and code segments to finally obtain compliant candidate user handwriting data, the printed matter of the digital version file being a printed matter of the target digital version file information.

The server acquires user handwriting data written by a user on a printed matter of the typeset and code-paved digital version file and fed back to an intelligent dot-matrix digital pen system, and takes the user handwriting data written by the user on the printed matter of the typeset and code-paved digital version file and fed back to the intelligent dot-matrix digital pen system as the user handwriting data to be processed on the printed matter of the digital version file. The user handwriting data to be processed may include handwriting data and user information. On-chain preprocessing (serializing and information signing) is performed on the user information in the user handwriting data to be processed. Based on the user information after the on-chain preprocessing, on-chain preprocessing (serializing and information signing) is performed on the handwriting data in the registered user handwriting data to be processed, to obtain handwriting data to be verified. Registration, transaction broadcasting, block consensus, contract logic processing and storing are performed on the handwriting data to be verified, to obtain on-chain handwriting data to be verified.

The server acquires identification information, publishing unit information and publication information corresponding to the printed matter based on target digital version file information (i.e., the printed matter of the digital version file) in advance, and performs blockchain on-chain registration on the identification information, the publishing unit information and the publication information to obtain printed matter information after the on-chain registration, where the printed matter may be a dot-matrix paper printed matter; and acquires seller data and sales user data corresponding to the apparatus, device, terminal and other products based on target digital version contents in advance, and performs blockchain on-chain registration on the seller data and sales user data, to obtain handwriting product information after the on-chain registration.

Based on the target digital version file information, the server retrieves the code source and code segment information registered on the blockchain, the printed matter information after the on-chain registration, and the handwriting product information after the on-chain registration, to obtain corresponding comparative code sources and code segments, comparative printed matter information and comparative handwriting product information; and performs matching (compliance verification) on the on-chain handwriting data to be verified through the comparative code sources and code segments, the comparative printed matter information and the comparative handwriting product information, respectively, and only when all the three are matched, the corresponding on-chain handwriting data to be verified can be determined as compliant candidate handwriting data. Alternatively, the server performs the compliance verification on the handwriting data to be verified through the comparative code sources and code segments, and then preforms re-verification on the on-chain handwriting data to be verified through the comparative printed matter information and the comparative handwriting product information. Only when the re-verification is passed, the corresponding on-chain handwriting data to be verified can be determined as compliant candidate handwriting data.

At step 104, code source and code segment compliance verification on the candidate user handwriting data, digital copyright compliance verification of handwriting carrier, and on-chain registration and on-chain storage management are performed to obtain target user handwriting data.

The server acquires product information corresponding to the initial user handwriting data, and acquires corresponding code sources and code segments from the code source and code segment information registered on the blockchain according to the product information; performs code source and code segment inquiry and compliance verification on the candidate user handwriting data, and identifies a digital copyright issued by a digital carrier in the candidate user handwriting data to obtain a handwriting copyright; performs verification on the handwriting copyright through the above acquired code sources and code segments, and if the verification is passed, acquires copyright configuration information, performs handwriting copyright registration and performs registration recording on the candidate user handwriting data according to the copyright configuration information to obtain registered candidate user handwriting data. Registration recording information includes writer information corresponding to the candidate user handwriting data, an identifier of a dot-matrix digital pen device, the candidate user handwriting data and a digital carrier of the handwriting, etc.

The server performs fragmentation and index creation on the registered candidate user handwriting data to obtain fragmented data, encrypts the fragmented data through a preset encryption algorithm to obtain encrypted fragmented data, stores the encrypted fragmented data in a preset handwriting copyright management storage node according to a preset blockchain storage strategy, and performs unified management on the registered candidate user handwriting data through the handwriting copyright management storage node, where the preset blockchain storage strategy includes the size and amount of the fragmented data of each storage node.

It should be noted that the actual technical processing flow is as follows: 1. on-chain registration of code sources and code segments from manufacturers/developers; 2. code-paving: acquiring from the chain the code sources that a code-paving user/organization is authorized to use, acquiring a required length of code segments from the code sources, converting the code segments in a graphics way and paving them on each page of an original digital printed matter to generate a code-paved digital version content file; 3. on-chain operation of a code-paved file: on-chain registration of a code-paved digital version content file, generation of digital copyright information of the code-paved digital version content file, and distribution of the code-paved digital version content file to a writing user after being printed; 4. writing: the writing user using a digital pen to write on the aforementioned printed matter, generation of a digital writing matter file with handwriting in a system on the basis of a copy of the written and code-paved digital version content file, and on-chain registration of “writing user information+used pen information+digital writing matter information” after the digital writing matter file has passed verification (file source and user authorization of the used code-paved file is verified on the chain); and 5. reading: a reader/reviewer being able to acquire, with a token authorized by the system, the digital writing matter file produced by a previous writer from the chain for reading; or compliance verification on a digital writing matter file obtained from a third party through the blockchain.

In embodiments of the present disclosure, with the blockchain, core data (initial code sources and code segments, code segments required for code-paving, and user handwriting data to be processed) of various links in the process is used for on-chain registration, and associating and mapping are performed on the data (the initial code sources and code segments, the code segments required for code-paving, and the user handwriting data to be processed) based on link dependency relationships, which solves problems regarding to data tracing and copyright management caused by the fact that code segments open and authorized to publishers, printers, consumers and other users, and code sources can only be managed by individual manufacturers, and cannot be open in a credible manner, universal and easy to use, and realizes credible tracing and copyright management of the initial code sources and code segments, target code-paving information and the user handwriting data to be processed, thus improving the data tracing accuracy and copyright protection degree of digital contents and other relevant information.

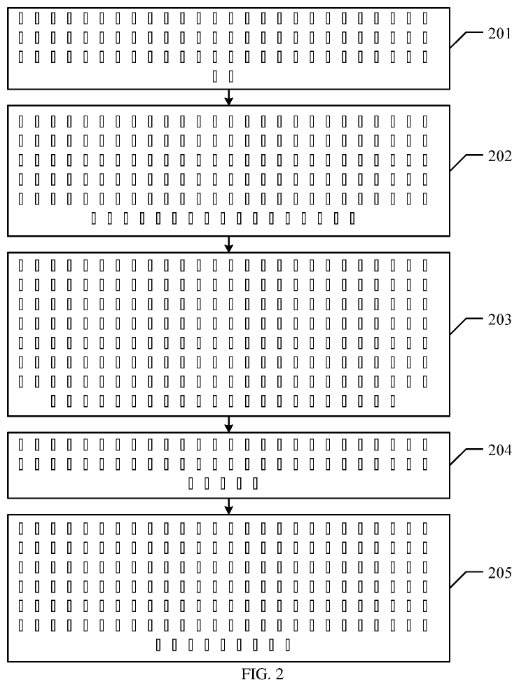

Referring to FIG. 2, another embodiment of the management method for user handwriting data in the embodiments of the present disclosure includes steps 201 to 205.

At step 201, initial code sources and code segments are acquired, and blockchain on-chain registration and unified management are performed on the initial code sources and code segments to obtain code source and code segment information registered on a blockchain, the initial code sources and code segments being code sources and code segments from various dot-matrix digital pen manufacturers or various dot-matrix digital pen developers.

Specifically, the server acquires, according to requirement conditions of the code sources and code segments, corresponding initial code sources and code segments from preset manufacturer code source management systems containing multiple code sources, the initial code sources and code segments being code sources and code segments from various dot-matrix digital pen manufacturers or various dot-matrix digital pen developers; performs blockchain block data packaging, metadata extraction and directory replication on the initial code sources and code segments to obtain code sources and code segments after on-chain registration; and performs authorization management on the code sources and code segments after the on-chain registration to obtain code source and code segment information registered on the blockchain, the code source and code segment information registered on the blockchain including code source and code segment information and copyright information registered in compliance on the blockchain.

According to extraction (management) conditions and business requirements of code sources and code segments from different dot-matrix digital pen manufacturers (or different dot-matrix digital pen developers) in the preset database, the server extracts corresponding initial code sources and code segments from respective preset databases of code source management systems (i.e., preset manufacturer code source management systems containing multiple code sources) of the different dot-matrix digital pen manufacturers (or different dot-matrix digital pen developers), where the requirement conditions of the code sources and code segments may be code sources and code segments corresponding to the dot-matrix digital pen manufacturers (or the dot-matrix digital pen developers) that need to be registered on the chain, which is not limited here.

The server packs, according to a chain data structure of a preset blockchain, the initial code sources and code segments into block data for blockchain transaction broadcasting, block consensus, contract logic processing and storing, to obtain candidate code sources and code segments, performs key structure metadata extraction on the candidate code sources and code segments to obtain target metadata, replicates the target metadata to a data directory of the blockchain to obtain code sources and code segments after on-chain registration, and performs authorization management on the code sources and code segments after the on-chain registration to obtain blockchain handwriting code sources and code segments. Further, optionally, according to a preset dot-matrix code field (or a dot-matrix code screening condition), retrieving (or screening) is performed on the handwriting code sources and code segments after the on-chain registration to obtain initial dot-matrix codes. Registration information verification and screening is performed on the initial dot-matrix codes to obtain registered dot-matrix codes. Authorization configuration information is acquired from a configuration library, and the authorization configuration information is used to indicate an authorized user and dot-matrix codes that the authorized user can use, and authorized user information is acquired. Through the authorized user information and the authorization configuration information, the registered dot-matrix codes are authorized and verified, and once the verification is passed, the authorization configuration is performed to obtain configured code sources and code segments after the on-chain registration. And, a key pair is generated, and the configured code sources and code segments after the on-chain registration are encrypted with the key pair and then are stored, so as to obtain the code source and code segment information registered on the blockchain. The code source and code segment information registered on the blockchain includes the code source and code segment information and copyright information that have been compliantly registered on the blockchain. It is convenient for data tracing and copyright protection of user handwriting data in the future.

At step 202, code segments required for code-paving are acquired from the code source and code segment information registered on the blockchain according to code-paving requirements, typesetting and code-paving are performed on an original digital content file through a preset typesetting and code-paving system to obtain a typeset and code-paved digital version file, and blockchain on-chain registration is performed on the typeset and code-paved digital version file to obtain target digital version file information, the target digital version file information including a target digital version file, on-chain registration information and copyright information of the target digital version file.

Specifically, the server acquires, according to a preset condition of code-paving and an authority of a code paver, corresponding compliant code sources and code segments from code sources and code segments registered in compliance and authorized in the code source and code segment information registered on the blockchain, and performs dot code extraction on the compliant code sources and code segments to obtain code segments required for code-paving; performs recognizable graphic code conversion through a preset graphics algorithm and based on the code segments required for code-paving to obtain an image graphic code, and performs uniform distribution, coverage, and graphic code-paving on each page of an original digital content file through a preset typesetting and code-paving system to obtain a typeset and code-paved digital version file, where the code segments required for code-paving are processed through graphics algorithm operations and program processes, and each code point corresponds to generation of an image graphic code; and performs blockchain on-chain verification and on-chain registration sequentially on the typeset and code-paved digital version file to obtain target digital version file information, the target digital version file information including a target digital version file, on-chain registration information and copyright information after the on-chain registration of the target digital version file.

The server receives a request for typesetting and code-paving sent by an external terminal (which may be a typesetting and code-paving terminal); analyzes the request for typesetting and code-paving to obtain key information of code-paving, which indicates preset conditions of code-paving (the preset conditions include but are not limited to the number of pages of a digital file, layout size, code point types for code-paving, etc.), the authority of the code paver and dot code requirements; performs compliance verification on the request for typesetting and code-paving; performs retrieving, once the verification is passed, on the code sources and code segments registered in compliance and authorized in the code source and code segment information registered on the blockchain based on the preset conditions of code-paving and the authority of the code paver, to obtain corresponding retrieved handwriting code sources and code segments; performs registration information verification and compliance verification on the retrieved handwriting code sources and code segments to obtain compliant code sources and code segments; and extracts, based on the dot code requirements in the key information of code-paving, corresponding code segments required for code-paving from the compliant code sources and code segments, where the code segments required for code-paving include, but are not limited to, code source types, code segments, and the number of code points for typeset and code-paved dot codes. Further, based on the request for typesetting and code-paving, the server acquires a number of code points required for code-paving directly from the chain. The request for typesetting and code-paving carries information of a code-paving user/organization/merchant, required code sources, and the number of code points corresponding to the code sources required for code-paving. It is responsible for retrieving compliant code segments and returning them on the chain. Therefore, in this case, there is no verification of code sources and code segments during code-paving. For the request for code-paving, instead of directly interacting with the blockchain to obtain code points, a code segment (this code segment was also registered on the chain when it was initialized) is preset in a code-paving service. It is not needed for the code-paving service to calculate the returned code points on the chain, but to use the code points in the preset code segment. However, whether the authorization of this code segment is valid or not requires the compliance verification on the chain. In addition, records about the use of code points may be registered on the chain for subsequent tracing. In this case, there is a compliance verification on code segment usage.

The server converts, through a preset graphics algorithm (which may be a computer graphics algorithm, may be a raster graphics algorithm or other graphics algorithms) and based on the code segments required for code-paving, each code point into a small recognizable graphic code, thereby obtaining an image graphic code; acquires original digital version contents from a preset digital content library, where the original digital version contents may be original code point digital contents of the handwriting, and the original digital version contents include digital contents such as digital reading materials, digital textbooks, digital teaching aids or digital test papers; performs uniform distribution, coverage, and graphic code-paving on each page of an original digital content file through a preset typesetting and code-paving system to obtain a typeset and code-paved digital version file; and performs blockchain on-chain verification and on-chain registration on the typeset and code-paved digital version file to obtain target digital version file information, where the target digital version file information includes a target digital version file, on-chain registration information and copyright information after the on-chain registration of the target digital version file. Specifically, the server performs on-chain verification on the typeset and code-paved digital version file according to a preset on-chain condition to obtain the typeset and code-paved digital version file after the verification, and performs on-chain preprocessing on the typeset and code-paved digital version file after the verification to obtain the typeset and code-paved digital version file after the preprocessing. The on-chain preprocessing includes serializing and information signing. Transaction broadcasting, block consensus, and contract logic processing are performed on the typeset and code-paved digital version file to obtain the target digital version file information. It is convenient to realize accurate data tracing and copyright protection of digital content and other relevant information.

At step 203, user handwriting data written by a user on a printed matter of the typeset and code-paved digital version file and fed back to an intelligent dot-matrix digital pen system is acquired as user handwriting data to be processed on the printed matter of the digital version file, on-chain preprocessing is performed on the user handwriting data to be processed, a corresponding typeset and code-paved digital version file is inquired according to the user handwriting data to be processed after the on-chain preprocessing and code point information on the printed matter, and copyright compliance verification is performed on a file copyright of the typeset and code-paved digital version file and the used code sources and code segments to finally obtain compliant candidate user handwriting data, the printed matter of the digital version file being a printed matter of the target digital version file information.

Specifically, the server acquires dot code data set written by a user on a printed matter of the typeset and code-paved digital version file and fed back to an intelligent dot-matrix digital pen system, converts the dot code data set into user handwriting data through a preset sequential dot connection algorithm, which is taken as user handwriting data to be processed on the printed matter of the digital version file, performs serializing and information signing on the user handwriting data to be processed to obtain preprocessed user handwriting data, where the preprocessed user handwriting data includes writing process, time and coordinate information related to the handwriting data, digital version file information and copyright information corresponding to the printed matter for handwriting, code point information and code source information of the digital version file corresponding to the printed matter for handwriting, information of a writing user and hardware information of a dot-matrix intelligent pen used by the writing user, and the printed matter of the digital version file is a printed matter of the target digital version file information; and inquires a corresponding typeset and code-paved digital version file according to the preprocessed user handwriting data and the code point information on the printed matter, and performs copyright compliance verification on a file copyright of the typeset and code-paved digital version file and code sources and code segments used by the preprocessed user handwriting data, to finally obtain compliant candidate user handwriting data.

After the server acquires the user handwriting data to be processed, on-chain preprocessing (i.e., serializing and information signing of user information) and handwriting on-chain processing (i.e., serializing and information signing of handwriting data) is performed on the user handwriting data to be processed, to obtain preprocessed user handwriting data.

The server retrieves, according to the target digital version file information, the code source and code segment information registered on the blockchain to obtain the corresponding comparative code sources and code segments; determines, through the comparative code sources and code segments, whether the handwriting code sources and code segments in the preprocessed user handwriting data are compliant, if not, then returns the determination result and stops operation, and if so, determines whether the digital copyright issued by the digital carrier in the preprocessed user handwriting data is compliant and available, if so, then determines the preprocessed user handwriting data as candidate user handwriting data, and if not, then returns the determination result and stops operation, so as to realize compliance re-verification of the handwriting code sources and code segments and verification of the digital copyright issued by the digital carrier.

At step 204, code source and code segment compliance verification on the candidate user handwriting data, digital copyright compliance verification of handwriting carrier, and on-chain registration and on-chain storage management are performed to obtain target user handwriting data.

Specifically, the server performs code source and code segment inquiry and compliance verification on the candidate user handwriting data, and handwriting carrier digital copyright inquiry and compliance verification, and performs blockchain on-chain registration and copyright registration on the candidate user handwriting data that has passed the compliance verification to obtain compliant user handwriting data; and acquires a blockchain storage space and a blockchain storage strategy corresponding to the candidate user handwriting data, and stores the compliant user handwriting data in a blockchain node corresponding to the blockchain storage space according to the blockchain storage strategy to obtain target user handwriting data, the target user handwriting data including the candidate user handwriting data and on-chain information of the candidate user handwriting data.

The server performs code source and code segment inquiry and compliance verification on the candidate user handwriting data, acquires product information corresponding to the initial user handwriting data, and acquires corresponding user code sources and code segments from the code source and code segment information registered on the blockchain according to the product information; performs, through the user code sources and code segments, verification on the digital copyright issued by the digital carrier in the candidate user handwriting data to obtain the candidate user handwriting data that has passed the compliance verification; and acquires copyright configuration information, performs handwriting copyright registration and performs registration recording on the candidate user handwriting data that has passed the compliance verification according to the copyright configuration information to obtain compliant user handwriting data. Registration recording information includes writer information corresponding to the candidate user handwriting data, an identifier of a pen device, the candidate user handwriting data and the digital carrier of the handwriting, etc.

A blockchain storage space and a blockchain storage strategy corresponding to the candidate user handwriting data are acquired, and the compliant user handwriting data is stored in a blockchain node corresponding to the blockchain storage space according to the blockchain storage strategy to obtain target user handwriting data, the target user handwriting data including the candidate user handwriting data and on-chain information of the candidate user handwriting data. Optionally, further, the server extracts key information and creates an index based on the key information on the compliant user handwriting data to obtain a target index; and searches the preset database through the target index to obtain corresponding user historical handwriting data. According to preset classification elements, the compliant user handwriting data and the user historical handwriting data are classified to obtain classified handwriting data. Cluster analysis is performed on the classified handwriting data to obtain expected information. According to the expected information, a user portrait of the classified handwriting data is established to obtain user portrait data. The user portrait data includes various user portrait labels and handwriting data corresponding to the various user portrait labels. The blockchain storage space and the blockchain storage strategy corresponding to the candidate user handwriting data are acquired. The various dot-matrix digital pen manufacturers or the various dot-matrix digital pen developers corresponding to different handwriting data will have different blockchain storage spaces (i.e., blockchain nodes for storage) and blockchain storage strategies. The blockchain storage strategies include storage ratio (e.g., dividing the user portrait data according to the storage ratio and then storing it), data size and data quantity corresponding to each blockchain node for storage, storage method, and stored data preprocessing (e.g., fragmentation processing and encryption processing), etc. The user portrait is encrypted to obtain encrypted user portrait data. According to the blockchain storage strategy, the encrypted user portrait data is stored to the blockchain node corresponding to the blockchain storage space to obtain the target user handwriting data.

At step 205, data to be verified and traced back is acquired, verification and inquiry are performed, based on the target user handwriting data, on the data to be verified and traced back to obtain verification and tracing information, and view mapping is performed on the verification and tracing information, where the verification and tracing information includes writing process, time and coordinate information related to the handwriting data, digital version file information and copyright information corresponding to the printed matter for handwriting, code point information and code source information of the digital version file corresponding to the printed matter for handwriting, information of a writing user and hardware information of a dot-matrix intelligent pen used by the writing user.

Specifically, the server receives a request for verification and tracing, and analyzes the request for verification and tracing and parameter data carried in the request for verification and tracing to obtain the data to be verified and traced back and requirements for verification and tracing; accesses and extracts the target user handwriting data from the blockchain, and performs, based on the target user handwriting data and the requirements for verification and tracing, verification and tracing and reconciliation on the data to be verified and traced back to obtain the verification and tracing information; and maps the verification and tracing information into a global virtual view through a preset global mapping rule, where the verification and tracing information includes writing process, time and coordinate information related to the handwriting data, digital version file information and copyright information corresponding to the printed matter for handwriting, code point information and code source information of the digital version file corresponding to the printed matter for handwriting, information of a writing user and hardware information of a dot-matrix intelligent pen used by the writing user.

The server receives a request for verification and tracing sent by a user terminal, and analyzes the request for verification and tracing and parameter data carried in the request for verification and tracing to obtain the data to be verified and traced back and requirements for verification and tracing. The data to be verified and traced back is the data corresponding to a user and a product related to the target user handwriting data. The data to be verified and traced back includes, but is not limited to, handwriting data and digital publication data to be verified and traced back. The requirements for verification and tracing include, but are not limited to, whether the writing is in compliance, whether the handwriting content has been tampered with, tracing of the writer of handwriting data, and whether the digital publication data is in compliance, etc.

The verification and tracing information includes comparison data, compared data and comparison results. Based on the request for verification and tracing, a preset monitoring access interface is called, so as to access and extract the target user handwriting data from the blockchain. When the requirement for verification and tracing is whether the writing is in compliance, code segments of the digital carrier in the target user handwriting data is compared with the handwriting data in the data be verified and traced back to obtain first comparison information, so as to prevent the dot-matrix digital pen from being used on a publication carrier with unauthorized code segments. When the requirement for verification and tracing is whether the handwriting content has been tampered with, a preset fully homomorphic encryption algorithm is called, and the handwriting content in the target user handwriting data is reconciled with the handwriting content in the data to be verified and traced back to obtain second comparison information, so as to prevent the handwriting content in the data to be verified and traced back from being tampered with. When the requirement for verification and tracing is the tracing the writer of the handwriting data, the handwriting data in the data to be verified and traced back is matched with the handwriting data in the target user handwriting data, and the corresponding writer information is acquired, so as to obtain third comparison information. When the requirement for verification and tracing is whether the digital publication data is in compliance, target information corresponding to the target user handwriting data is acquired, which includes publication information, work data and code segments, and the digital publication data in the data to be verified and traced back is reconciled with the target information to obtain fourth comparison information, so as to prevent pirated printed matters from using unauthorized code segments or the content from being tampered with. The first comparison information, the second comparison information, the third comparison information and the fourth comparison information are determined as the verification and tracing information. Optionally, the preset fully homomorphic encryption algorithm may be called, and based on the target user handwriting data and the requirements for verification and tracing, the data to be verified and traced back may be verified and traced back and reconciled to obtain the verification and tracing information. Through the fully homomorphic encryption algorithm, it is possible to calculate cipher-text data (the target user handwriting data) without decryption, without destroying sensitive source data of the target user handwriting data, and at the same time, the target user handwriting data can be processed (verification and tracing, and reconciliation).

The global mapping rule is a strategy for full view virtualization. The server performs on-chain registration on the verification and tracing information. The server acquires, based on the preset global mapping rule, a global field name, a local field name, entity information and a data dictionary of the verification and tracing information after the on-chain registration. According to the entity information and the data dictionary, the server performs mapping relationship creation, virtual view table writing, and view key value generation sequentially on the global field name and the local field name, thereby obtaining a global virtual view, reducing the complexity of accessing the target user handwriting data and the verification and tracing information, and realizing real-time and convenient data management.

Through verification, tracing and reconciliation of the data to be verified and traced back, the data tracing accuracy and copyright protection degree of digital contents and other relevant information are improved. Through the global virtual view mapping, the complexity of accessing the target user handwriting data and the verification and tracing information is reduced, and the real-time and convenient data management is realized.

In embodiments of the present disclosure, it not only solves problems regarding to data tracing and copyright management caused by the fact that code segments open and authorized to publishers, printers, consumers and other users, and code sources can only be managed by individual manufacturers, and cannot be open in a credible manner, universal and easy to use, which realizes credible tracing and copyright management of the initial code sources and code segments, the code segments required for code-paving, and the user handwriting data to be processed, thus improving the data tracing accuracy and copyright protection degree of digital contents and other relevant information; but also realizes accurate data tracing and copyright protection of digital contents and other relevant information. Through the global virtual view mapping, the complexity of accessing the target user handwriting data and the verification and tracing information is reduced, and the real-time and convenient data management is realized.

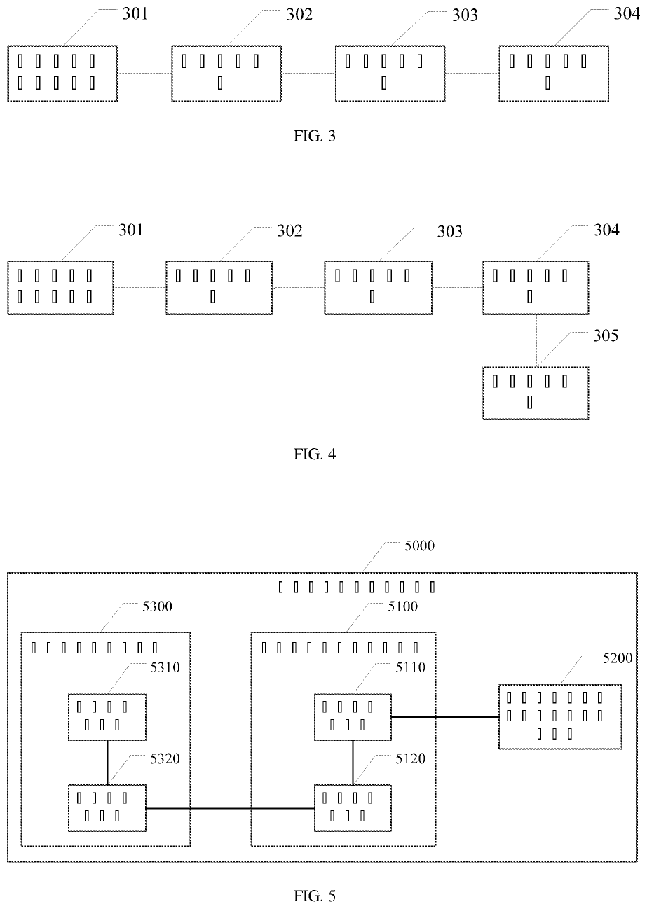

The management method for user handwriting data in the embodiments of the present disclosure is described above. The management apparatus for user handwriting data in the embodiments of the present disclosure is described below. Referring to FIG. 3, an embodiment of the management apparatus for user handwriting data in the embodiments of the present disclosure includes:
a code source and code segment on-chain management module 301 configured for acquiring initial code sources and code segments, and performing blockchain on-chain registration and unified management on the initial code sources and code segments to obtain code source and code segment information registered on a blockchain, the initial code sources and code segments being code sources and code segments from various dot-matrix digital pen manufacturers or various dot-matrix digital pen developers;
a typesetting and code-paving module 302 configured for acquiring code segments required for code-paving from the code source and code segment information registered on the blockchain according to code-paving requirements, performing typesetting and code-paving on an original digital content file through a preset typesetting and code-paving system to obtain a typeset and code-paved digital version file, and performing blockchain on-chain registration on the typeset and code-paved digital version file to obtain target digital version file information, the target digital version file information including a target digital version file, on-chain registration information and copyright information of the target digital version file;
a first verification module 303 configured for acquiring user handwriting data written by a user on a printed matter of the typeset and code-paved digital version file and fed back to an intelligent dot-matrix digital pen system, as user handwriting data to be processed on the printed matter of the digital version file, performing on-chain preprocessing on the user handwriting data to be processed, inquiring a corresponding typeset and code-paved digital version file according to the user handwriting data to be processed after the on-chain preprocessing and code point information on the printed matter, and performing copyright compliance verification on a file copyright of the typeset and code-paved digital version file and the used code sources and code segments to finally obtain compliant candidate user handwriting data, the printed matter of the digital version file being a printed matter of the target digital version file information; and
a second verification module 304 configured for performing code source and code segment compliance verification on the candidate user handwriting data, digital copyright compliance verification of handwriting carrier, and on-chain registration and on-chain storage management to obtain target user handwriting data.

The implementation of functions of various modules in the above-mentioned management apparatus for user handwriting data corresponds to various steps in the embodiments of the above-mentioned management method for user handwriting data, and its functions and implementation processes will not be repeated here.

In embodiments of the present disclosure, with the blockchain, core data (initial code sources and code segments, code segments required for code-paving, and user handwriting data to be processed) of various links in the process is used for on-chain registration, and associating and mapping are performed on the data (the initial code sources and code segments, the code segments required for code-paving, and the user handwriting data to be processed) based on link dependency relationships, which solves problems regarding to data tracing and copyright management caused by the fact that code segments open and authorized to publishers, printers, consumers and other users, and code sources can only be managed by individual manufacturers, and cannot be open in a credible manner, universal and easy to use, and realizes credible tracing and copyright management of the initial code sources and code segments, target code-paving information and the user handwriting data to be processed, thus improving the data tracing accuracy and copyright protection degree of digital contents and other relevant information.

Referring to FIG. 4, another embodiment of the management apparatus for user handwriting data in the embodiments of the present disclosure includes:
a code source and code segment on-chain management module 301 configured for acquiring initial code sources and code segments, and performing blockchain on-chain registration and unified management on the initial code sources and code segments to obtain code source and code segment information registered on a blockchain, the initial code sources and code segments being code sources and code segments from various dot-matrix digital pen manufacturers or various dot-matrix digital pen developers;
a typesetting and code-paving module 302 configured for acquiring code segments required for code-paving from the code source and code segment information registered on the blockchain according to code-paving requirements, performing typesetting and code-paving on an original digital content file through a preset typesetting and code-paving system to obtain a typeset and code-paved digital version file, and performing blockchain on-chain registration on the typeset and code-paved digital version file to obtain target digital version file information, the target digital version file information including a target digital version file, on-chain registration information and copyright information of the target digital version file;
a first verification module 303 configured for acquiring user handwriting data written by a user on a printed matter of the typeset and code-paved digital version file and fed back to an intelligent dot-matrix digital pen system, as user handwriting data to be processed on the printed matter of the digital version file, performing on-chain preprocessing on the user handwriting data to be processed, inquiring a corresponding typeset and code-paved digital version file according to the user handwriting data to be processed after the on-chain preprocessing and code point information on the printed matter, and performing copyright compliance verification on a file copyright of the typeset and code-paved digital version file and the used code sources and code segments to finally obtain compliant candidate user handwriting data, the printed matter of the digital version file being a printed matter of the target digital version file information;
a second verification module 304 configured for performing code source and code segment compliance verification on the candidate user handwriting data, digital copyright compliance verification of handwriting carrier, and on-chain registration and on-chain storage management to obtain target user handwriting; and
a verification and mapping module 305 configured for acquiring data to be verified and traced back, performing, based on the target user handwriting data, verification and inquiry on the data to be verified and traced back to obtain verification and tracing information, and performing view mapping on the verification and tracing information, where the verification and tracing information includes writing process, time and coordinate information related to the handwriting data, digital version file information and copyright information corresponding to the printed matter for handwriting, code point information and code source information of the digital version file corresponding to the printed matter for handwriting, information of a writing user and hardware information of a dot-matrix intelligent pen used by the writing user.

Optionally, the code source and code segment on-chain management module 301 may further be specifically configured for:
acquiring, according to requirement conditions of the code sources and code segments, corresponding initial code sources and code segments from preset manufacturer code source management systems containing multiple code sources, the initial code sources and code segments being code sources and code segments from various dot-matrix digital pen manufacturers or various dot-matrix digital pen developers;
performing blockchain block data packaging, metadata extraction and directory replication on the initial code sources and code segments to obtain code sources and code segments after on-chain registration; and
performing authorization management on the code sources and code segments after the on-chain registration to obtain code source and code segment information registered on the blockchain, the code source and code segment information registered on the blockchain including code source and code segment information and copyright information registered in compliance on the blockchain.

Optionally, the typesetting and code-paving module 302 may further be specifically configured for:
acquiring, according to a preset condition of code-paving and an authority of a code paver, corresponding compliant code segments from code sources and code segments registered in compliance and authorized in the code source and code segment information registered on the blockchain, and performing dot code extraction on the compliant code segments to obtain code segments required for code-paving;
performing recognizable graphic code conversion through a preset graphics algorithm and based on the code segments required for code-paving, to obtain an image graphic code, and performing uniform distribution, coverage, and graphic code-paving on each page of an original digital content file through a preset typesetting and code-paving system, to obtain a typeset and code-paved digital version file, where the code segments required for code-paving are processed through graphics algorithm operations and program processes, and each code point corresponds to generation of an image graphic code; and
performing blockchain on-chain verification and on-chain registration sequentially on the typeset and code-paved digital version file to obtain target digital version file information, the target digital version file information including a target digital version file, on-chain registration information and copyright information after the on-chain registration of the target digital version file.

Optionally, the first verification module 303 may further be specifically configured for:
acquiring dot code data set written by a user on a printed matter of the typeset and code-paved digital version file and fed back to an intelligent dot-matrix digital pen system, converting the dot code data set into user handwriting data through a preset sequential dot connection algorithm, which is taken as user handwriting data to be processed on the printed matter of the digital version file, performing serializing and information signing on the user handwriting data to be processed to obtain preprocessed user handwriting data, where the preprocessed user handwriting data includes writing process, time and coordinate information related to the handwriting data, digital version file information and copyright information corresponding to the printed matter for handwriting, code point information and code source information of the digital version file corresponding to the printed matter for handwriting, information of a writing user and hardware information of a dot-matrix intelligent pen used by the writing user, and the printed matter of the digital version file is a printed matter of the target digital version file information; and
inquiring a corresponding typeset and code-paved digital version file according to the preprocessed user handwriting data and the code point information on the printed matter, and performing copyright compliance verification on a file copyright of the typeset and code-paved digital version file and code sources and code segments used by the preprocessed user handwriting data, to finally obtain compliant candidate user handwriting data.

Optionally, the second verification module 304 may further be specifically configured for:
performing code source and code segment inquiry and compliance verification on the candidate user handwriting data, and handwriting carrier digital copyright inquiry and compliance verification, and performing blockchain on-chain registration and copyright registration on the candidate user handwriting data that has passed the compliance verification to obtain compliant user handwriting data; and
acquiring a blockchain storage space and a blockchain storage strategy corresponding to the candidate user handwriting data, and storing the compliant user handwriting data in a blockchain node corresponding to the blockchain storage space according to the blockchain storage strategy to obtain target user handwriting data, the target user handwriting data including the candidate user handwriting data and on-chain information of the candidate user handwriting data.

Optionally, the verification and mapping module 305 may further be specifically configured for:
receiving a request for verification and tracing, and analyzing the request for verification and tracing and parameter data carried in the request for verification and tracing to obtain the data to be verified and traced back and requirements for verification and tracing;
accessing and extracting the target user handwriting data from the blockchain, and performing, based on the target user handwriting data and the requirements for verification and tracing, on-chain verification and tracing and reconciliation on the data to be verified and traced back to obtain the verification and tracing information, where the verification and tracing information includes writing process, time and coordinate information related to the handwriting data, digital version file information and copyright information corresponding to the printed matter for handwriting, code point information and code source information of the digital version file corresponding to the printed matter for handwriting, information of a writing user and hardware information of a dot-matrix intelligent pen used by the writing user; and
mapping the verification and tracing information into a global virtual view through a preset global mapping rule.

The implementation of functions of various modules and various units in the above-mentioned management apparatus for user handwriting data corresponds to various steps in the embodiments of the above-mentioned management method for user handwriting data, and its functions and implementation processes will not be repeated here.

In embodiments of the present disclosure, it not only solves problems regarding to data tracing and copyright management caused by the fact that code segments open and authorized to publishers, printers, consumers and other users, and code sources can only be managed by individual manufacturers, and cannot be open in a credible manner, universal and easy to use, which realizes credible tracing and copyright management of the initial code sources and code segments, the code segments required for code-paving, and the user handwriting data to be processed, thus improving the data tracing accuracy and copyright protection degree of digital contents and other relevant information; but also realizes accurate data tracing and copyright protection of digital contents and other relevant information. Through the global virtual view mapping, the complexity of accessing the target user handwriting data and the verification and tracing information is reduced, and the real-time and convenient data management is realized.

In the above FIG. 3 and FIG. 4, the management apparatus for user handwriting data in the embodiments of the present disclosure is described in detail from the perspective of modular functional entities. In the following, the management apparatus for user handwriting data in the embodiments of the present disclosure is described in detail from the perspective of hardware processing.

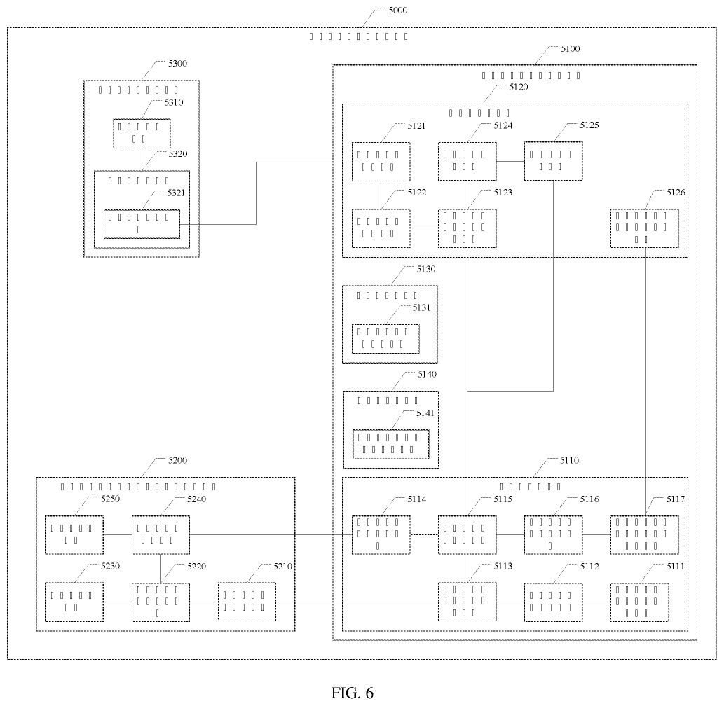

FIG. 5 is a schematic structure diagram of a management system 5000 for user handwriting data provided in the embodiments of the present disclosure. The management system 5000 for user handwriting data carries out the above-described management method for user handwriting data. The management system 5000 for user handwriting data includes a blockchain copyright authentication and management system 5100, a blockchain-based digital typesetting and code-paving printing system 5200, and an intelligent dot-matrix digital pen system 5300. The blockchain copyright authentication and management system 5100 includes a production link subsystem 5110 and an application link subsystem 5120. The production link subsystem 5110 is configured for management of code sources and code segments and a typeset and code-paved digital file, and the application link subsystem 5120 is configured for application of a typeset and code-paved printed matter, on-chain registration and storage of handwriting, copyright inquiry and compliance application. The intelligent dot-matrix digital pen system 5300 includes an intelligent dot-matrix digital pen 5310 and an application system server 5320. The production link subsystem 5110 is connected to the blockchain-based digital typesetting and code-paving printing system 5200. Further, the production link subsystem 5110 is unidirectionally connected to the blockchain-based digital typesetting and code-paving printing system 5200. The blockchain-based digital typesetting and code-paving printing system 5200 only acquires compliant code segments for dot codes registered on the chain from the production link subsystem 5110, and then performs code-paving printing. Code points of a code segment used in the production link subsystem 5110 will be marked with usage history on the chain. The basis for judging the code points of the used code segment is that when the code points of the code segment are acquired before code-paving, they are synchronously written into usage history data on the chain. If the code points of the code segment are then used to generate code-paving files and registered on the chain, the code-paving files will be associated with the code points of the used code segment on the chain, so which code points of the code segment have been used and which code-paving files have been generated can be traced back and inquired on the chain. The blockchain-based digital typesetting and code-paving printing system 5200 is indirectly connected to the intelligent dot-matrix digital pen system 5300 through the application link subsystem 5120. The intelligent dot-matrix digital pen system 5300 is connected to the blockchain copyright authentication and management system 5100. Further, the intelligent dot-matrix digital pen system 5300 may be bidirectionally or unidirectionally connected to the blockchain copyright authentication and management system 5100. Firstly, information of the intelligent dot-matrix digital pen 5310 will be registered on the blockchain. In addition, the handwriting (which is related to the user and the pen) generated during the use of the intelligent dot-matrix digital pen 5310 will also be registered on the blockchain. The intelligent dot-matrix digital pen 5310 and the blockchain copyright authentication and management system 5100 may be bidirectionally connected and mutually verify data during use. The production link subsystem 5110 is configured for acquiring initial code sources and code segments, and performing blockchain on-chain registration and unified management on the initial code sources and code segments to obtain code source and code segment information registered on a blockchain, the initial code sources and code segments being code sources and code segments from various dot-matrix digital pen manufacturers or various dot-matrix digital pen developers. The blockchain-based digital typesetting and code-paving printing system 5200 is configured for acquiring code segments required for code-paving from the code source and code segment information registered on the blockchain according to code-paving requirements, performing typesetting and code-paving on an original digital content file through a preset typesetting and code-paving system to obtain a typeset and code-paved digital version file, and performing blockchain on-chain registration on the typeset and code-paved digital version file to obtain target digital version file information, the target digital version file information including a target digital version file, on-chain registration information and copyright information of the target digital version file. The intelligent dot-matrix digital pen 5310 is configured for sending user handwriting data to be processed on a printed matter of the digital version file to the application system server 5320, the user handwriting data to be processed on the printed matter of the digital version file being user handwriting data written by a user on the printed matter of the typeset and code-paved digital version file and fed back to the intelligent dot-matrix digital pen system. The application system server 5320 is configured for performing on-chain preprocessing on the user handwriting data to be processed to obtain the user handwriting data to be processed after the on-chain preprocessing, and sending the user handwriting data to be processed after the on-chain preprocessing to the application link subsystem 5120. The application link subsystem 5120 is configured for acquiring user handwriting data written by a user on the printed matter of the typeset and code-paved digital version file and fed back to the intelligent dot-matrix digital pen system, as user handwriting data to be processed on the printed matter of the digital version file, performing on-chain preprocessing on the user handwriting data to be processed, inquiring a corresponding typeset and code-paved digital version file according to the user handwriting data to be processed after the on-chain preprocessing and code point information on the printed matter, and performing copyright compliance verification on a file copyright of the typeset and code-paved digital version file and the used code sources and code segments to finally obtain compliant candidate user handwriting data, the printed matter of the digital version file being a printed matter of the target digital version file information; and performing code source and code segment compliance verification on the candidate user handwriting data, digital copyright compliance verification of handwriting carrier, and on-chain registration and on-chain storage management to obtain target user handwriting data.

In the present disclosure, through the management system 5000 for user handwriting data, with regard to process links in an actual application process of a dot-matrix digital pen, such as digital content production, digital content publishing and issuing, digital content typesetting and printing, printed matter publishing and issuing, sales and circulation, and writing or answering on a printed matter with the dot-matrix digital pen, core data of each link in the use process is registered on the chain by using a blockchain technology, and the data is correlated and mapped based on link dependence, thus realizing credible data tracing and copyright management from two aspects of application process and specific link data. In the present disclosure, the data registered on the chain includes: code sources and code segments of dot-matrix codes (including code source manufacturers), an original version of digital contents (including authors), a typeset and code-paved version of digital contents (including publishers), a paper version of dot-matrix papers (including printers) obtained after printing the typeset and code-paved digital contents, sales and circulation channels and users (including sales and circulation channels), and digital handwriting (including writers) generated by writing on the paper version with the dot-matrix digital pen, etc. The above-mentioned links and data are realized through a blockchain technology, and unified registration, authorization, authentication, association, tracing, verification and other management on the chain are realized. Problems of data tracing and copyright protection such as accurate tracing of digital contents, accurate tracing of publishing and issuing information of digital contents, tracing of compliance verification and publishing and issuing of a published and printed matter based on dot-matrix paper, tracing of a writer who uses a dot-matrix digital pen, authenticity of handwriting and tamper-proof reconciliation are solved.

FIG. 6 is another schematic structure diagram of a management system 5000 for user handwriting data provided in the embodiments of the present disclosure. Specifically, the management system 5000 for user handwriting data includes a blockchain copyright authentication and management system 5100, a blockchain-based digital typesetting and code-paving printing system 5200, and an intelligent dot-matrix digital pen system 5300. The blockchain copyright authentication and management system 5100 includes the production link subsystem 5110, the application link subsystem 5120, a sales link subsystem 5130 and a publication link subsystem 5140. The production link subsystem 5110 includes an on-chain registration module for code sources and code segments of dot-matrix codes 5111, an authorization management module for code sources and code segments 5112, an unified management and tracing module for code sources and code segments 5113, an on-chain preprocessing module for digital contents 5114, a tracing and verification module for code sources and code segments 5115, a registration module for digital version work contents 5116, and a tracing management module for digital version work contents and code segments 5117. The sales link subsystem 5130 includes a work publication sales management module 5131. The publication link subsystem 5140 includes a work printed matter information registration management module 5141. The application link subsystem 5120 includes a user on-chain preprocessing module 5121, a handwriting on-chain preprocessing module 5122, a digital copyright verification module for handwriting carrier 5123, a handwriting copyright registration module 5124, a handwriting copyright management module 5125, and a compliance reconciliation module for work published and printed matter 5126. The blockchain-based digital typesetting and code-paving printing system 5200 includes a module for acquiring code sources and code segments of dot codes 5210, a digital typesetting and code-paving management module 5220, a digital content library module 5230, a digital code-paving version management module 5240 and a dot-matrix paper printing module 5250. The intelligent dot-matrix digital pen system 5300 includes the intelligent dot-matrix digital pen 5310 and the application system server 5320. The application system server 5320 includes a user handwriting on-chain module 5321.

The production link subsystem 5110 mainly realizes data on-chain management of the code sources and code segments of the dot-matrix codes (including the code source manufacturers), the original version of digital contents (including the authors), and the typeset and code-paved version of digital contents (including the publishers). The application link subsystem 5120 mainly realizes data on-chain management of digital handwriting (including the writer) generated by a user using the dot-matrix digital pen to write on the paper version of dot-matrix papers. A publication link subsystem mainly realizes data on-chain management of the paper version of dot-matrix papers (including the printers) obtained after printing the typeset and code-paved version of digital contents. The sales link subsystem 5130 mainly realizes data on-chain management of sales and circulation channels and sales users (including sales and circulation channels).

The sales link subsystem 5130 mainly realizes data on-chain management of sales and circulation channels and sales users (including sales and circulation channels). For the data management of the sales and circulation channels and the sales users, with the help of an external interface provided by the “work publication sales management module 5131” in the blockchain copyright authentication and management system 5100, a third party may upload data of sellers and sales users of the dot-matrix digital pen and the dot-matrix paper printed matter to the chain, and perform unified data recording and management on the sales and circulation channels and the sales users on the chain, so that the sales users and channels may be further traced back to provide better quality value-added services through pushing, tracing, and return-visiting, etc. In addition, the dot-matrix paper printed matter requires a matching dot-matrix digital pen to be effectively used and form a digital handwriting. Therefore, effective identification of sales users may be carried out by identifying the type of the dot-matrix digital pen and the user data on the chain, so as to select users with dot-matrix digital pen types suitable for the code sources for sales. Moreover, credible data of the sales users and the sales channels may provide a data basis for further identifying the compliance of the publication and the compliance of the digital copyright, and provide effective data support for analyzing and identifying the compliances of the publication and the digital copyright.

The publication link subsystem mainly realizes data on-chain management of the paper version of dot-matrix papers (including the printers) obtained after printing the typeset and code-paved version of digital contents. For the data management of the paper version of dot-matrix papers, firstly, the typeset and code-paved version of digital contents is printed through dot-matrix papers to form a dot-matrix paper printed matter. With an external interface provided by the “work printed matter information registration management module 5141” in the blockchain copyright authentication and management system 5100, a third party may upload identification information on the dot-matrix paper printed matter, and publication information, such as a publishing unit and a book/serial number of the printed matter, to the chain, and perform unified data recording and management of the printed matter on the chain. The dot-matrix paper printed matter may be printed using different code segments during code-paving, or may be printed using the same code segment. If different code segments are used for printing, the code points on each page of each dot-matrix paper printed matter are unique. Each dot-matrix paper printed matter is bound with used code segment data and then is uploaded to the chain, so that the code segments used by each printed matter can be traced back on the chain, and the compliance of each printed matter can be verified through the code segments. If the same code segment is used for printing, the code points on each page of each dot-matrix paper printed matter are the same. However, by adding a unique identification code or uniquely identifiable mark to each dot-matrix paper printed matter, it is possible that the identifier of each dot-matrix paper printed matter is bound with used code segment data and then is uploaded to the chain, so that the compliance of each printed matter and the compliance of the used code segment therein is verified on the chain. In the above two methods, with the help of the blockchain copyright authentication and management system 5100, whether each dot-matrix paper printed matter is a compliant publication or a compliant printed matter can be indirectly verified by means of the identifier of the dot-matrix paper printed matter or the code points and code segments therein.

The on-chain registration module for code sources and code segments of dot-matrix codes 5111 is configured for acquiring, according to requirement conditions of the code sources and code segments, initial code sources and code segments from preset manufacturer code source management systems containing multiple code sources, and performing blockchain block data packaging, metadata extraction and directory replication on the initial code sources and code segments to obtain code sources and code segments after on-chain registration. The authorization management module for code sources and code segments 5112 and the unified management and tracing module for code sources and code segments 5113 are configured for performing authorization management, encryption and storing, unified management and tracing on the code sources and code segments after the on-chain registration to obtain code source and code segment information registered on the blockchain, the code source and code segment information registered on the blockchain including code source and code segment information and copyright information registered in compliance on the blockchain.

The module for acquiring code sources and code segments of dot codes 5210 is configured for initiating a request for typesetting and code-paving to the unified management and tracing module for code sources and code segments 5113. The unified management and tracing module for code sources and code segments 5113 receives this request for typesetting and code-paving; performs analyzing and compliance verification on the request for typesetting and code-paving; acquires, based on the request for typesetting and code-paving that has passed the verification and according to a preset condition of code-paving and an authority of a code paver, corresponding compliant code segments from code sources and code segments registered in compliance and authorized in the code source and code segment information registered on the blockchain; and performs dot code extraction on the compliant code segments to obtain code segments required for code-paving. The digital typesetting and code-paving management module 5220 is configured for performing recognizable graphic code conversion through a preset graphics algorithm and based on the code segments required for code-paving, to obtain an image graphic code, where the code segments required for code-paving are processed through graphics algorithm operations and program processes, and each code point corresponds to generation of an image graphic code. Digital contents (that is, original digital version contents, e.g., digital contents such as digital reading materials, digital teaching materials, digital teaching aids or digital test papers) that need to be typeset and code-paved are selected from the digital content library module 5230. Firstly, systematic typesetting is performed, the digital typesetting and code-paving management module 5220 performs uniform distribution, coverage, and graphic code-paving on each page of an original digital content file through a preset typesetting and code-paving system, to obtain a typeset and code-paved digital version file. With the digital code-paving version management module 5240, the on-chain preprocessing module for digital contents 5114, the tracing and verification module for code sources and code segments 5115, and the unified management and tracing module for code sources and code segments 5113, blockchain on-chain verification and on-chain registration are performed on the typeset and code-paved digital version file to obtain target digital version file information, the target digital version file information including a target digital version file, on-chain registration information and copyright information after the on-chain registration of the target digital version file. The registration module for digital version work contents 5116 is configured for registering the target digital version file information and recording information of an issuing unit/person, an issuing time, digital contents, etc. The tracing management module for digital version work contents and code segments 5117 is configured for managing the registered target digital version file information and the recorded information, and recording original information of the digital version work, such as the author's unit/the author, specific contents and code segments used. The dot-matrix paper printing module 5250 is configured for performing dot-matrix paper printing based on the target digital version file information to form a dot-matrix paper printed matter, which is transferred to subsequent publishing and issuing links and is published and issued in a paper version (dot-matrix paper printed matter). The work printed matter information registration management module 5141 calls the preset external interface to upload identification information of a printed matter published and issued in a paper version (dot-matrix paper printed matter) to the chain, and records publication information, such as a publishing unit and a book/serial number at the same time. After the paper version (dot-matrix paper printed matter) is published and issued, corresponding intelligent dot-matrix digital pens are sold to organizations/users. The work publication sales management module 5131 calls the preset external interface to perform on-chain management on sales data, and records sales organization/user information.

The intelligent dot-matrix digital pen 5310 is a new type of writing instrument including a pressure sensor, a miniature camera and a network communication module. Before using the intelligent dot-matrix digital pen 5310, it is necessary to perform code-paving, that is, a layer of high-precision and almost invisible dot-matrix pattern (dot-matrix codes) is printed on an ordinary paper as positioning coordinates of the paper. It is necessary for the intelligent dot-matrix digital pen 5310 to write on a suitable dot-matrix paper (the intelligent dot-matrix digital pen 5310 can correctly identify dot code coordinates on the dot-matrix paper). When writing, the pressure sensor in the pen receives a pressure, and the high-speed camera at the front end of the digital pen captures a movement track of the tip of the pen at any time, identifies coordinate code points that the movement passes through, and sends the identified coordinate data and pressure data of the pressure sensor back to a data processor in time sequence. The data is output to the outside through Bluetooth, Wi-Fi or a USB interface, and the writing trajectory is digitized, so as to obtain user handwriting data written by a user on the printed matter of the typeset and code-paved digital version file and fed back to the intelligent dot-matrix digital pen system (i.e., user handwriting data to be processed on the printed matter of the digital version file), and send the user handwriting data to be processed to the application system server 5320 for storage (such as structured database, cache, etc.), transmission (such as Internet, local area networks, etc.), browsing (such as tablet, mobile phone, PC browser, etc.) with the help of information technologies, thus realizing remote cooperation between the writer and the reader across time and space. With the user handwriting on-chain module 5321, on-chain preprocessing is performed on the user handwriting data to be processed to obtain the user handwriting data to be processed after the on-chain preprocessing, and the user handwriting data to be processed after the on-chain preprocessing is sent to the user on-chain preprocessing module 5121 of the blockchain copyright authentication and management system 5100.

The user on-chain preprocessing module 5121 performs a user on-chain operation on the user handwriting data to be processed after on-chain preprocessing; and performs, through the handwriting on-chain preprocessing module 5122 and the tracing and verification module for code sources and code segments 5115 and based on blockchain handwriting code sources and code segments acquired by the unified management and tracing module for code sources and code segments 5113, dot code registration analysis and dot code compliance and usability analysis on the user handwriting data to be processed after on-chain preprocessing, to obtain candidate user handwriting data. The digital copyright verification module for handwriting carrier 5123 is configured for performing carrier copyright compliance verification on the candidate user handwriting data based on the blockchain handwriting code sources and code segments acquired by the unified management and tracing module for code sources and code segments 5113. The handwriting copyright registration module 5124 is configured for performing blockchain handwriting copyright registration on the candidate user handwriting data that has passed the compliance verification and performing registration recording, to obtain user handwriting data after registration recording. The handwriting copyright management module 5125 is configured for managing the user handwriting data after registration recording, and realizing requirements for verification and tracing, i.e., whether the writing is in compliance, whether the handwriting content has been tampered with, and tracing of the writer of handwriting data. With the tracing management module for digital version work contents and code segments 5117, target information corresponding to the target user handwriting data is acquired, the target information including publication information, work data and code segments. The compliance reconciliation module for work published and printed matter 5126 is configured for reconciling the digital publication data in the data to be verified and traced back with the target information, so as to prevent pirated printed matters from using unauthorized code segments or the content from being tampered with.

The present disclosure further provides a computer-readable storage medium, which may be a non-volatile computer-readable storage medium, or may also be a volatile computer-readable storage medium. The computer-readable storage medium stores computer programs, which, when running on a computer, cause the computer to execute steps of the management method for user handwriting data.

Further, the computer-readable storage medium may mainly include a program storage area and a data storage area, where the program storage area may store an operating system, an application program required by at least one function, etc.; and the storage data area may store data created according to the use of blockchain nodes.

The blockchain referred to in the present disclosure is a new application mode of computer technologies such as distributed data storage, point-to-point transmission, consensus mechanism, and encryption algorithm. Blockchain is essentially a decentralized database, which is a series of data blocks generated in association using cryptographic methods. Each data block contains information about a batch of network transactions, for verifying the validity of its information (anti-counterfeiting) and generating a next block. The blockchain may include a blockchain underlying platform, a platform product service layer, an application service layer, etc.

Those skilled in the art may clearly understand that for the convenience and brevity of the description, specific working processes of the above-described system, apparatus and unit may refer to corresponding processes in the foregoing method embodiments, which will not be repeated here.

If an integrated unit is realized in the form of a software function unit and sold or used as an independent product, it can be stored in a computer-readable storage medium. Based on this understanding, the essence of the technical solution of the present disclosure or the part that contributes to the prior art or all or some of the technical solution can be embodied in the form of a software product, and the computer software product is stored in a storage medium, including several computer programs for enabling a computer device (which may be a personal computer, server, or network device, etc.) to execute all or some of the steps of the methods in various embodiments of the present disclosure. The aforementioned storage media include: USB disks, mobile hard disks, read-only memories (ROMs), random access memories (RAMs), magnetic disks or optical disks, and various media that can store program codes.

The above embodiments are only used to illustrate the technical solutions of the present disclosure, not to limit them; although the present disclosure has been described in detail with reference to the foregoing embodiments, it should be understood by those of ordinary skills in the art that: it is still possible to modify the technical solutions described in the foregoing embodiments, or to equivalently replace some technical features thereof. These modifications or substitutions do not make the essence of the corresponding technical solutions deviate from the spirit and scope of the technical solutions of various embodiments of the present disclosure.

1. A management method for user handwriting data, comprising:
acquiring initial code sources and code segments, and performing blockchain on-chain registration and unified management on the initial code sources and code segments to obtain code source and code segment information registered on a blockchain, the initial code sources and code segments being code sources and code segments from various dot-matrix digital pen manufacturers or various dot-matrix digital pen developers;
acquiring code segments required for code-paving from the code source and code segment information registered on the blockchain according to code-paving requirements, performing typesetting and code-paving on an original digital content file through a preset typesetting and code-paving system to obtain a typeset and code-paved digital version file, and performing blockchain on-chain registration on the typeset and code-paved digital version file to obtain target digital version file information, the target digital version file information comprising a target digital version file, on-chain registration information and copyright information of the target digital version file;
acquiring user handwriting data written by a user on a printed matter of the typeset and code-paved digital version file and fed back to an intelligent dot-matrix digital pen system, as user handwriting data to be processed on the printed matter of the digital version file, performing on-chain preprocessing on the user handwriting data to be processed, inquiring a corresponding typeset and code-paved digital version file according to the user handwriting data to be processed after the on-chain preprocessing and code point information on the printed matter, and performing copyright compliance verification on a file copyright of the typeset and code-paved digital version file and the used code sources and code segments to finally obtain compliant candidate user handwriting data, the printed matter of the digital version file being a printed matter of the target digital version file information; and
performing code source and code segment compliance verification on the candidate user handwriting data, digital copyright compliance verification of handwriting carrier, and on-chain registration and on-chain storage management to obtain target user handwriting data.

2. The management method for user handwriting data according to claim 1, wherein, the acquiring initial code sources and code segments, and performing blockchain on-chain registration and unified management on the initial code sources and code segments to obtain code source and code segment information registered on a blockchain, the initial code sources and code segments being code sources and code segments from various dot-matrix digital pen manufacturers or various dot-matrix digital pen developers, comprise:
acquiring, according to requirement conditions of the code sources and code segments, corresponding initial code sources and code segments from preset manufacturer code source management systems containing multiple code sources, the initial code sources and code segments being code sources and code segments from various dot-matrix digital pen manufacturers or various dot-matrix digital pen developers;
performing blockchain block data packaging, metadata extraction and directory replication on the initial code sources and code segments to obtain code sources and code segments after on-chain registration; and
performing authorization management on the code sources and code segments after the on-chain registration to obtain code source and code segment information registered on the blockchain, the code source and code segment information registered on the blockchain comprising code source and code segment information and copyright information registered in compliance on the blockchain.

3. The management method for user handwriting data according to claim 1, wherein, the acquiring code segments required for code-paving from the code source and code segment information registered on the blockchain according to code-paving requirements, performing typesetting and code-paving on an original digital content file through a preset typesetting and code-paving system to obtain a typeset and code-paved digital version file, and performing blockchain on-chain registration on the typeset and code-paved digital version file to obtain target digital version file information, the target digital version file information comprising a target digital version file, on-chain registration information and copyright information of the target digital version file, comprise:
acquiring, according to a preset condition of code-paving and an authority of a code paver, corresponding compliant code segments from code sources and code segments registered in compliance and authorized in the code source and code segment information registered on the blockchain, and performing dot code extraction on the compliant code segments to obtain code segments required for code-paving;
performing recognizable graphic code conversion through a preset graphics algorithm and based on the code segments required for code-paving, to obtain an image graphic code, and performing uniform distribution, coverage, and graphic code-paving on each page of an original digital content file through a preset typesetting and code-paving system, to obtain a typeset and code-paved digital version file, wherein the code segments required for code-paving are processed through graphics algorithm operations and program processes, and each code point corresponds to generation of an image graphic code; and
performing blockchain on-chain verification and on-chain registration sequentially on the typeset and code-paved digital version file to obtain target digital version file information, the target digital version file information comprising a target digital version file, on-chain registration information and copyright information after the on-chain registration of the target digital version file.

4. The management method for user handwriting data according to claim 1, wherein in that, the acquiring user handwriting data written by a user on a printed matter of the typeset and code-paved digital version file and fed back to an intelligent dot-matrix digital pen system, as user handwriting data to be processed on the printed matter of the digital version file, performing on-chain preprocessing on the user handwriting data to be processed, inquiring a corresponding typeset and code-paved digital version file according to the user handwriting data to be processed after the on-chain preprocessing and code point information on the printed matter, and performing copyright compliance verification on a file copyright of the typeset and code-paved digital version file and the used code sources and code segments to finally obtain compliant candidate user handwriting data, the printed matter of the digital version file being a printed matter of the target digital version file information, comprise:
acquiring dot code data set written by a user on a printed matter of the typeset and code-paved digital version file and fed back to an intelligent dot-matrix digital pen system, converting the dot code data set into user handwriting data through a preset sequential dot connection algorithm, which is taken as user handwriting data to be processed on the printed matter of the digital version file, performing serializing and information signing on the user handwriting data to be processed to obtain preprocessed user handwriting data, wherein the preprocessed user handwriting data comprises writing process, time and coordinate information related to the handwriting data, digital version file information and copyright information corresponding to the printed matter for handwriting, code point information and code source information of the digital version file corresponding to the printed matter for handwriting, information of a writing user and hardware information of a dot-matrix intelligent pen used by the writing user, and the printed matter of the digital version file is a printed matter of the target digital version file information; and
inquiring a corresponding typeset and code-paved digital version file according to the preprocessed user handwriting data and the code point information on the printed matter, and performing copyright compliance verification on a file copyright of the typeset and code-paved digital version file and code sources and code segments used by the preprocessed user handwriting data, to finally obtain compliant candidate user handwriting data.

5. The management method for user handwriting data according to claim 1, wherein, the performing code source and code segment compliance verification on the candidate user handwriting data, digital copyright compliance verification of handwriting carrier, and on-chain registration and on-chain storage management to obtain target user handwriting data, comprise:
performing code source and code segment inquiry and compliance verification on the candidate user handwriting data, and handwriting carrier digital copyright inquiry and compliance verification, and performing blockchain on-chain registration and copyright registration on the candidate user handwriting data that has passed the compliance verification to obtain compliant user handwriting data; and
acquiring a blockchain storage space and a blockchain storage strategy corresponding to the candidate user handwriting data, and storing the compliant user handwriting data in a blockchain node corresponding to the blockchain storage space according to the blockchain storage strategy to obtain target user handwriting data, the target user handwriting data comprising the candidate user handwriting data and on-chain information of the candidate user handwriting data.

6. The management method for user handwriting data according to claim 1, wherein, after the performing code source and code segment compliance verification on the candidate user handwriting data, digital copyright compliance verification of handwriting carrier, and on-chain registration and on-chain storage management to obtain target user handwriting data, the method further comprises:
acquiring data to be verified and traced back, performing, based on the target user handwriting data, verification and inquiry on the data to be verified and traced back to obtain verification and tracing information, and performing view mapping on the verification and tracing information, wherein the verification and tracing information comprises writing process, time and coordinate information related to the handwriting data, digital version file information and copyright information corresponding to the printed matter for handwriting, code point information and code source information of the digital version file corresponding to the printed matter for handwriting, information of a writing user and hardware information of a dot-matrix intelligent pen used by the writing user.

7. The management method for user handwriting data according to claim 6, wherein, the acquiring data to be verified and traced back, performing, based on the target user handwriting data, verification and inquiry on the data to be verified and traced back to obtain verification and tracing information, and performing view mapping on the verification and tracing information, wherein the verification and tracing information comprises writing process, time and coordinate information related to the handwriting data, digital version file information and copyright information corresponding to the printed matter for handwriting, code point information and code source information of the digital version file corresponding to the printed matter for handwriting, information of a writing user and hardware information of a dot-matrix intelligent pen used by the writing user, comprise:
receiving a request for verification and tracing, and analyzing the request for verification and tracing and parameter data carried in the request for verification and tracing to obtain the data to be verified and traced back and requirements for verification and tracing;
accessing and extracting the target user handwriting data from the blockchain, and performing, based on the target user handwriting data and the requirements for verification and tracing, on-chain verification and tracing and reconciliation on the data to be verified and traced back to obtain the verification and tracing information, wherein the verification and tracing information comprises writing process, time and coordinate information related to the handwriting data, digital version file information and copyright information corresponding to the printed matter for handwriting, code point information and code source information of the digital version file corresponding to the printed matter for handwriting, information of a writing user and hardware information of a dot-matrix intelligent pen used by the writing user; and
mapping the verification and tracing information into a global virtual view through a preset global mapping rule.

8. A management apparatus for user handwriting data, comprising:
a code source and code segment on-chain management module configured for acquiring initial code sources and code segments, and performing blockchain on-chain registration and unified management on the initial code sources and code segments to obtain code source and code segment information registered on a blockchain, the initial code sources and code segments being code sources and code segments from various dot-matrix digital pen manufacturers or various dot-matrix digital pen developers;
a typesetting and code-paving module configured for acquiring code segments required for code-paving from the code source and code segment information registered on the blockchain according to code-paving requirements, performing typesetting and code-paving on an original digital content file through a preset typesetting and code-paving system to obtain a typeset and code-paved digital version file, and performing blockchain on-chain registration on the typeset and code-paved digital version file to obtain target digital version file information, the target digital version file information comprising a target digital version file, on-chain registration information and copyright information of the target digital version file;
a first verification module configured for acquiring user handwriting data written by a user on a printed matter of the typeset and code-paved digital version file and fed back to an intelligent dot-matrix digital pen system, as user handwriting data to be processed on the printed matter of the digital version file, performing on-chain preprocessing on the user handwriting data to be processed, inquiring a corresponding typeset and code-paved digital version file according to the user handwriting data to be processed after the on-chain preprocessing and code point information on the printed matter, and performing copyright compliance verification on a file copyright of the typeset and code-paved digital version file and the used code sources and code segments to finally obtain compliant candidate user handwriting data; and
a second verification module configured for performing code source and code segment compliance verification on the candidate user handwriting data, digital copyright compliance verification of handwriting carrier, and on-chain registration and on-chain storage management to obtain target user handwriting data.

9. A management system for user handwriting data, comprising a blockchain copyright authentication and management system, a blockchain-based digital typesetting and code-paving printing system, and an intelligent dot-matrix digital pen system; wherein
the blockchain copyright authentication and management system comprises a production link subsystem and an application link subsystem, the production link subsystem being configured for management of code sources and code segments and a typeset and code-paved digital file, and the application link subsystem being configured for application of a typeset and code-paved printed matter, on-chain registration and storage of handwriting, copyright inquiry and compliance application;
the intelligent dot-matrix digital pen system comprises an intelligent dot-matrix digital pen and an application system server;
the production link subsystem is connected to the blockchain-based digital typesetting and code-paving printing system;
the blockchain-based digital typesetting and code-paving printing system is indirectly connected to the intelligent dot-matrix digital pen system through the application link subsystem;
the intelligent dot-matrix digital pen system is connected to the blockchain copyright authentication and management system;
the production link subsystem is configured for acquiring initial code sources and code segments, and performing blockchain on-chain registration and unified management on the initial code sources and code segments to obtain code source and code segment information registered on a blockchain, the initial code sources and code segments being code sources and code segments from various dot-matrix digital pen manufacturers or various dot-matrix digital pen developers;
the blockchain-based digital typesetting and code-paving printing system is configured for acquiring code segments required for code-paving from the code source and code segment information registered on the blockchain according to code-paving requirements, performing typesetting and code-paving on an original digital content file through a preset typesetting and code-paving system to obtain a typeset and code-paved digital version file, and performing blockchain on-chain registration on the typeset and code-paved digital version file to obtain target digital version file information, the target digital version file information comprising a target digital version file, on-chain registration information and copyright information of the target digital version file;
the intelligent dot-matrix digital pen is configured for sending user handwriting data to be processed on a printed matter of the digital version file to the application system server, the user handwriting data to be processed on the printed matter of the digital version file being user handwriting data written by a user on the printed matter of the typeset and code-paved digital version file and fed back to the intelligent dot-matrix digital pen system;
the application system server is configured for performing on-chain preprocessing on the user handwriting data to be processed to obtain the user handwriting data to be processed after the on-chain preprocessing, and sending the user handwriting data to be processed after the on-chain preprocessing to the application link subsystem; and
the application link subsystem is configured for acquiring user handwriting data written by a user on the printed matter of the typeset and code-paved digital version file and fed back to the intelligent dot-matrix digital pen system, as user handwriting data to be processed on the printed matter of the digital version file, performing on-chain preprocessing on the user handwriting data to be processed, inquiring a corresponding typeset and code-paved digital version file according to the user handwriting data to be processed after the on-chain preprocessing and code point information on the printed matter, and performing copyright compliance verification on a file copyright of the typeset and code-paved digital version file and the used code sources and code segments to finally obtain compliant candidate user handwriting data, the printed matter of the digital version file being a printed matter of the target digital version file information; and performing code source and code segment compliance verification on the candidate user handwriting data, digital copyright compliance verification of handwriting carrier, and on-chain registration and on-chain storage management to obtain target user handwriting data.

10. A computer-readable storage medium storing a computer program thereon, wherein, the computer program, when executed by a processor, implements the management method for user handwriting data according to claim 1.

11. The management method for user handwriting data according to claim 2, wherein, after the performing code source and code segment compliance verification on the candidate user handwriting data, digital copyright compliance verification of handwriting carrier, and on-chain registration and on-chain storage management to obtain target user handwriting data, the method further comprises:
acquiring data to be verified and traced back, performing, based on the target user handwriting data, verification and inquiry on the data to be verified and traced back to obtain verification and tracing information, and performing view mapping on the verification and tracing information, wherein the verification and tracing information comprises writing process, time and coordinate information related to the handwriting data, digital version file information and copyright information corresponding to the printed matter for handwriting, code point information and code source information of the digital version file corresponding to the printed matter for handwriting, information of a writing user and hardware information of a dot-matrix intelligent pen used by the writing user.

12. The management method for user handwriting data according to claim 3, wherein, after the performing code source and code segment compliance verification on the candidate user handwriting data, digital copyright compliance verification of handwriting carrier, and on-chain registration and on-chain storage management to obtain target user handwriting data, the method further comprises:
acquiring data to be verified and traced back, performing, based on the target user handwriting data, verification and inquiry on the data to be verified and traced back to obtain verification and tracing information, and performing view mapping on the verification and tracing information, wherein the verification and tracing information comprises writing process, time and coordinate information related to the handwriting data, digital version file information and copyright information corresponding to the printed matter for handwriting, code point information and code source information of the digital version file corresponding to the printed matter for handwriting, information of a writing user and hardware information of a dot-matrix intelligent pen used by the writing user.

13. The management method for user handwriting data according to claim 4, wherein, after the performing code source and code segment compliance verification on the candidate user handwriting data, digital copyright compliance verification of handwriting carrier, and on-chain registration and on-chain storage management to obtain target user handwriting data, the method further comprises:
acquiring data to be verified and traced back, performing, based on the target user handwriting data, verification and inquiry on the data to be verified and traced back to obtain verification and tracing information, and performing view mapping on the verification and tracing information, wherein the verification and tracing information comprises writing process, time and coordinate information related to the handwriting data, digital version file information and copyright information corresponding to the printed matter for handwriting, code point information and code source information of the digital version file corresponding to the printed matter for handwriting, information of a writing user and hardware information of a dot-matrix intelligent pen used by the writing user.

14. The management method for user handwriting data according to claim 5, wherein, after the performing code source and code segment compliance verification on the candidate user handwriting data, digital copyright compliance verification of handwriting carrier, and on-chain registration and on-chain storage management to obtain target user handwriting data, the method further comprises:
acquiring data to be verified and traced back, performing, based on the target user handwriting data, verification and inquiry on the data to be verified and traced back to obtain verification and tracing information, and performing view mapping on the verification and tracing information, wherein the verification and tracing information comprises writing process, time and coordinate information related to the handwriting data, digital version file information and copyright information corresponding to the printed matter for handwriting, code point information and code source information of the digital version file corresponding to the printed matter for handwriting, information of a writing user and hardware information of a dot-matrix intelligent pen used by the writing user.

15. The computer-readable storage medium storing the computer program thereon of claim 10, wherein the acquiring initial code sources and code segments, and performing blockchain on-chain registration and unified management on the initial code sources and code segments to obtain code source and code segment information registered on a blockchain, the initial code sources and code segments being code sources and code segments from various dot-matrix digital pen manufacturers or various dot-matrix digital pen developers, comprise:
acquiring, according to requirement conditions of the code sources and code segments, corresponding initial code sources and code segments from preset manufacturer code source management systems containing multiple code sources, the initial code sources and code segments being code sources and code segments from various dot-matrix digital pen manufacturers or various dot-matrix digital pen developers;
performing blockchain block data packaging, metadata extraction and directory replication on the initial code sources and code segments to obtain code sources and code segments after on-chain registration; and
performing authorization management on the code sources and code segments after the on-chain registration to obtain code source and code segment information registered on the blockchain, the code source and code segment information registered on the blockchain comprising code source and code segment information and copyright information registered in compliance on the blockchain.

16. The computer-readable storage medium storing the computer program thereon of claim 10, the acquiring code segments required for code-paving from the code source and code segment information registered on the blockchain according to code-paving requirements, performing typesetting and code-paving on an original digital content file through a preset typesetting and code-paving system to obtain a typeset and code-paved digital version file, and performing blockchain on-chain registration on the typeset and code-paved digital version file to obtain target digital version file information, the target digital version file information comprising a target digital version file, on-chain registration information and copyright information of the target digital version file, comprise:
acquiring, according to a preset condition of code-paving and an authority of a code paver, corresponding compliant code segments from code sources and code segments registered in compliance and authorized in the code source and code segment information registered on the blockchain, and performing dot code extraction on the compliant code segments to obtain code segments required for code-paving;
performing recognizable graphic code conversion through a preset graphics algorithm and based on the code segments required for code-paving, to obtain an image graphic code, and performing uniform distribution, coverage, and graphic code-paving on each page of an original digital content file through a preset typesetting and code-paving system, to obtain a typeset and code-paved digital version file, wherein the code segments required for code-paving are processed through graphics algorithm operations and program processes, and each code point corresponds to generation of an image graphic code; and
performing blockchain on-chain verification and on-chain registration sequentially on the typeset and code-paved digital version file to obtain target digital version file information, the target digital version file information comprising a target digital version file, on-chain registration information and copyright information after the on-chain registration of the target digital version file.

17. The computer-readable storage medium storing the computer program thereon of claim 10, wherein the acquiring user handwriting data written by a user on a printed matter of the typeset and code-paved digital version file and fed back to an intelligent dot-matrix digital pen system, as user handwriting data to be processed on the printed matter of the digital version file, performing on-chain preprocessing on the user handwriting data to be processed, inquiring a corresponding typeset and code-paved digital version file according to the user handwriting data to be processed after the on-chain preprocessing and code point information on the printed matter, and performing copyright compliance verification on a file copyright of the typeset and code-paved digital version file and the used code sources and code segments to finally obtain compliant candidate user handwriting data, the printed matter of the digital version file being a printed matter of the target digital version file information, comprise:
acquiring dot code data set written by a user on a printed matter of the typeset and code-paved digital version file and fed back to an intelligent dot-matrix digital pen system, converting the dot code data set into user handwriting data through a preset sequential dot connection algorithm, which is taken as user handwriting data to be processed on the printed matter of the digital version file, performing serializing and information signing on the user handwriting data to be processed to obtain preprocessed user handwriting data, wherein the preprocessed user handwriting data comprises writing process, time and coordinate information related to the handwriting data, digital version file information and copyright information corresponding to the printed matter for handwriting, code point information and code source information of the digital version file corresponding to the printed matter for handwriting, information of a writing user and hardware information of a dot-matrix intelligent pen used by the writing user, and the printed matter of the digital version file is a printed matter of the target digital version file information; and
inquiring a corresponding typeset and code-paved digital version file according to the preprocessed user handwriting data and the code point information on the printed matter, and performing copyright compliance verification on a file copyright of the typeset and code-paved digital version file and code sources and code segments used by the preprocessed user handwriting data, to finally obtain compliant candidate user handwriting data.

18. The computer-readable storage medium storing the computer program thereon of claim 10, wherein the performing code source and code segment compliance verification on the candidate user handwriting data, digital copyright compliance verification of handwriting carrier, and on-chain registration and on-chain storage management to obtain target user handwriting data, comprise:
performing code source and code segment inquiry and compliance verification on the candidate user handwriting data, and handwriting carrier digital copyright inquiry and compliance verification, and performing blockchain on-chain registration and copyright registration on the candidate user handwriting data that has passed the compliance verification to obtain compliant user handwriting data; and
acquiring a blockchain storage space and a blockchain storage strategy corresponding to the candidate user handwriting data, and storing the compliant user handwriting data in a blockchain node corresponding to the blockchain storage space according to the blockchain storage strategy to obtain target user handwriting data, the target user handwriting data comprising the candidate user handwriting data and on-chain information of the candidate user handwriting data.

19. The computer-readable storage medium storing the computer program thereon of claim 10, wherein after the performing code source and code segment compliance verification on the candidate user handwriting data, digital copyright compliance verification of handwriting carrier, and on-chain registration and on-chain storage management to obtain target user handwriting data, the method further comprises:
acquiring data to be verified and traced back, performing, based on the target user handwriting data, verification and inquiry on the data to be verified and traced back to obtain verification and tracing information, and performing view mapping on the verification and tracing information, wherein the verification and tracing information comprises writing process, time and coordinate information related to the handwriting data, digital version file information and copyright information corresponding to the printed matter for handwriting, code point information and code source information of the digital version file corresponding to the printed matter for handwriting, information of a writing user and hardware information of a dot-matrix intelligent pen used by the writing user.

20. The computer-readable storage medium storing the computer program thereon of claim 19, the acquiring data to be verified and traced back, performing, based on the target user handwriting data, verification and inquiry on the data to be verified and traced back to obtain verification and tracing information, and performing view mapping on the verification and tracing information, wherein the verification and tracing information comprises writing process, time and coordinate information related to the handwriting data, digital version file information and copyright information corresponding to the printed matter for handwriting, code point information and code source information of the digital version file corresponding to the printed matter for handwriting, information of a writing user and hardware information of a dot-matrix intelligent pen used by the writing user, comprise:
receiving a request for verification and tracing, and analyzing the request for verification and tracing and parameter data carried in the request for verification and tracing to obtain the data to be verified and traced back and requirements for verification and tracing;
accessing and extracting the target user handwriting data from the blockchain, and performing, based on the target user handwriting data and the requirements for verification and tracing, on-chain verification and tracing and reconciliation on the data to be verified and traced back to obtain the verification and tracing information, wherein the verification and tracing information comprises writing process, time and coordinate information related to the handwriting data, digital version file information and copyright information corresponding to the printed matter for handwriting, code point information and code source information of the digital version file corresponding to the printed matter for handwriting, information of a writing user and hardware information of a dot-matrix intelligent pen used by the writing user; and
mapping the verification and tracing information into a global virtual view through a preset global mapping rule.
